(19) United States
(12) Patent Application Publication
(10) Pub. No.: US 2023/0075067 A1
(43) Pub. Date: Mar. 9, 2023

(54) Systems and Methods for Resource Analysis, Optimization, or Visualization

(71) Applicant: Prashanth Iyengar, Irvine, CA (US)

(72) Inventor: Prashanth Iyengar, Irvine, CA (US)

(21) Appl. No.: 17/931,839

(22) Filed: Sep. 13, 2022

Related U.S. Application Data
(63) Continuation-in-part of application No. 17/403,860, filed on Aug. 16, 2021, now Pat. No. 11,443,513.
Application No. 17/403,860 is a continuation of application No. PCT/US20/31638, filed on May 6, 2020.
(60) Provisional application No. 62/967,037, filed on Jan. 29, 2020.

(51) Int. Cl. G06V 20/52; G06V 20/40; G06Q 10/06

(52) U.S. Cl. CPC G06V 20/52; G06V 20/44; G06Q 10/06398

(57) ABSTRACT

A system and method for distributed surveillance of an area to monitor a process and visual effects of the process. Exemplary methods include, among others, asset effectiveness, issue identification and prioritization, workflow optimization, monitoring, estimation, verification, compliance, presentation, and/or identification for a given process. Such application may include, but are not limited to, manufacturing, quality control, supply chain management, and safety compliance.

### PRIORITY

This application claims priority as a continuation-in-part to U.S. application Ser. No. 17/403,860, filed Aug. 16, 2021, now U.S. Pat. No. 11,443,513, which claims priority as a continuation to international patent application number PCT/US20/31638, filed May 6, 2020, which claims priority to U.S. Provisional Application No. 62/967,037, filed Jan. 29, 2020, each of which is incorporated by reference in its entirety herein.

### BACKGROUND

Many processes occur that require repetition or step-wise application of resources. For example, in conventional assembly line manufacturing, an object is created as a part, passes through different stations and additional components are built or received and then assembled to the part. Other processes that include repetitive actions may include quality inspections of finished products. Other processes may include inspections during field use, such as, for example, inspection of oil pipes for assessing defects or determining the need for repairs. Many inefficiencies arise in such system as one part of the line may be backed up, while other parts are not utilized, during such back up or otherwise.

Traditional approaches to optimize operations generally involve manual observation and inferences by Subject Matter Experts (SMEs) or other operational manager. For example, traditional approaches may involve optimizing operations outcomes like improving Operational Equipment Efficiency (OEE), by performing time studies. A subject matter expert or manager would manually monitor or track inefficiencies for a duration. Monitoring may include tracking machine up and down time, machine through put, amount of scrap or incidence of rework monitoring, etc. However, such processes are highly manual and require the presence of SMEs to observe, monitor, and collect data to infer root causes and then propose changes. Observations and studies to determine issues are done by sampling the process at various times of operation, which does not capture all variations in the process (e.g. material variation, machine performance variation, operator performance, etc.).

Traditional approaches may also incorporate automated systems that are highly reliant on hardware and optimizing aspects of OEE like improving machine up time. Internet of Things (IoT) sensors may be included through a machine process to track specific information, such as machine up and down time, asset tracking, etc. An approach relying on IoT sensors requires attaching sensors to almost every entity that needs to be monitored or moving the sensors between entities. Additionally, these sensors require periodic maintenance or replacement. In order to facilitate changing the location of the sensors or replace existing sensors with newer ones requires installation effort. This makes the process even harder to scale. The data generated by all of the sensors may be so vast that they require processing on site as transferring information to remote processing locations can be expensive. However, hardware processing resources are typically limited on site, and thus, the quality of inferences or analytics provided by the system is similarly limited. Many of the IoT sensors used in such systems are also generally wireless devices that may be affected by signal occlusion, fading, shadowing effects, which makes the sensors unreliable and the processing performed on such information inaccurate. In order to overcome the challenge of scale such systems are narrow in their application (e.g. predictive maintenance of machines) and do not cover all aspect of OEE improvements. Such systems are also narrow in the variety of root cause identification and prioritization of inefficiencies as the assessment is limited by the assumptions made in pre-identifying the entities to be monitored and tracked.

### SUMMARY

Exemplary embodiments of the system and methods described herein may permit manufacturing and other process organizations to optimize business processes to drive better outcomes using a scalable and customizable platform including Internet of Things (IoT), Cloud processing, Augmented Intelligence (AI), Machine Learning (ML), Signal Processing algorithms, and combinations thereof.

### FIGURES

FIG. 1A illustrates an exemplary process floor that may benefit from embodiments described herein.

FIG. 1 illustrates the technology components of an exemplary system that may perform the functions described herein, for example, such as components for data sources, processing, analytics, and visualization.

FIG. 2 illustrate exemplary pre-processor and aggregation algorithms and details according to embodiments described herein.

FIG. 3 illustrates the exemplary analytics according to embodiments described herein to generate the features and benefits described herein.

FIGS. 4-7C illustrate exemplary processes describing the pre-processor and aggregation algorithms described in FIG. 2.

FIG. 8 illustrates an exemplary Process Block of the Instantaneous Snap Shot Processing Estimator Block of FIG. 2.

FIG. 9 illustrates an exemplary Process Block of the State Based Time-Dependence Processing Block of FIG. 2.

FIGS. 10-12 provides an exemplary sequence based neural net model to compute process metrics according to embodiments described herein.

FIGS. 13-21 illustrate exemplary displays that may be used to visualize according to embodiments described herein.

FIG. 22 illustrates an exemplary system according to embodiments described herein.

FIGS. 23-29 illustrate exemplary displays that may be used to visualize information according to embodiments described herein.

FIG. 30 illustrates an exemplary flow chart of an exemplary process according to embodiments described herein.

FIGS. 31-36 illustrate exemplary displays that may be used to visualize information according to embodiments described herein.

FIG. 37 illustrates exemplary modules of a system according to embodiments described herein.

### DESCRIPTION

The following detailed description illustrates by way of example, not by way of limitation, the principles of the invention. This description will clearly enable one skilled in the art to make and use the invention, and describes several embodiments, adaptations, variations, alternatives and uses of the invention, including what is presently believed to be the best mode of carrying out the invention. It should be understood that the drawings are diagrammatic and schematic representations of exemplary embodiments of the invention, and are not limiting of the present invention nor are they necessarily drawn to scale.

Exemplary embodiments described herein include a connected signal source architecture. Processed information from one signal source serves as an input to enable processing of another signal source. Exemplary embodiments may reduce the need to process all the signal sources all the time. For example, in the case of cameras or acoustic sensors, precision is inversely proportional to the field of view covered. Hence, most systems are forced to trade-off between the two and pick a compromise. Exemplary embodiments of the connected sensor system provide the best of both worlds by having a set of sensors address precision requirements while other sensors address field of view/scope (e.g. space, frequency coverage etc.) requirements. Accordingly, exemplary embodiments described herein may comprise multiple sensors, such as cameras, photo eye, proximity detectors, metal inductance sensor, lasers, etc. The multiple sensors, such as cameras, may be connected through processing algorithms such that an output from one sensor may inform an input to another sensor, and/or may provide control signals to another sensor. Exemplary embodiments include sequential processing, iterative processing, parallel processing, and combinations thereof. Exemplary embodiments may balance the trade-offs and/or permit a user to control the trade-offs between scope and precision.

Exemplary embodiments described herein may be used to provide an automated, continuous monitoring and data capture solution. The system may permit Continuous Improvement (CI), Industrial Engineer (IE), or Field Test Engineer (FTE), or other personnel to focus on a solution rather than data collection and identification. Exemplary embodiments described herein include a camera led implementation with sensors augmenting the capability as and when required. The cameras may be deployed in less density than conventional sensor monitoring and cover greater processes or area of observation. Cameras also permit a universal system application that does not require sensor selection for individual applications. For example, in the case of Internet of Things (IoT) sensors, we may need one type of sensor to monitor pressure changes and another type of sensor to monitor temperature changes. Cameras also permit the separation of the camera from the process or entity being observed so that exemplary embodiments of the system described herein do not interfere with operations. Cameras may also include a longer operation lifecycle than conventional sensors previously used to monitor processes, entities, and systems. Exemplary embodiments also overcome conventional image processing challenges or data processing bandwidth, as exemplary algorithms described herein permit data processing and identification that is accurate, fast, easy to scale, affordable, with reduced data processing computation. Cameras are an example of a signal source described herein. Cameras are not limited to the visual spectrum continuous data capture devices for replay on a display, but may include any large field sensor detector that may take continuous data or sequential periodic data feeds. For example, cameras for detecting different frequency bands may be included within the understanding of camera, including heat detection cameras, night vision cameras, etc. Cameras may also include depth detectors. Other camera ranges in different frequencies may also be included in the scope of the instant application. Exemplary embodiments of camera may include any physical sensor capable of wide area observation or receipt of information. This may include acoustic (sound) sensors.

Exemplary examples of the camera system may include mechanically controlled system. For example, one or more cameras may be on a moveable stage, or may be controlled to adaptively or dynamically change a tilt, direction (pan), and/or zoom of the camera. In an exemplary embodiment, the system according to embodiments described herein include a first camera positioned in a high level location. High level location is understood to include a large scale view of an area or part of the process under observation. One or more second cameras may be positioned at a low level location. The low level location may permit closer perspective with greater detail of a subarea or object of observation. The low level location may be a portion or subset within the high level location or may be a different location outside of the high level location. The low level location may be observed with a camera and/or with one or more other sensors. In an exemplary embodiment, the high level location and low level location may be observed with the same camera. For example, the tilt, pan, and/or zoom may be used to transition from the high level location to and from the low level location. Exemplary embodiments may therefore include adaptive systems in which an output from one or more component or part of the system may be used as an input to another part of the system. The input may be used to control portions of the system.

Alternatively, or in addition thereto, the system may be configured as a static system with cameras configured simultaneously and separately for the high level location and the low level location. Exemplary embodiments may therefore include multiple cameras (or sensors) that can combine the scope and precision with and without adaptive pan, tilt, and zoom. The system may control either automatically and/or manually to transition between the high level location and low level location based on the inputs to the system and the analysis currently being performed.

Although exemplary embodiments described herein are in terms of cameras, the invention is not so limited. Additional sensors and/or monitoring devices may also be used in conjunction with cameras. For example, in critical areas or in any area of interest or as desired based on the process, equipment in use, or any other reason, additional sensors may be included and monitored and analyzed according to embodiments described herein. IoT sensors or IoT like sensors (e.g. Barcode scans, IR sensors, object trackers, Human based button presses, mobile electronic devices for user inputs, etc.) may be used in conjunction with cameras to provide additional visibility in key critical areas of the process for monitoring.

Exemplary embodiments may permit visualization to optimize and determine an effective process for application to a business process. Exemplary embodiments include visualization of a workflow, such as through a graph. The system may be used to identify branch joint points in the graph. The system may prioritize branch joints based on branch level depth (measured from the end of the process), user input (process manager or other system user), initial experiments, and combinations thereof. The system may then track relative measure of throughput/inefficiency of one branch relative to another using exemplary tools, methods, and analysis described herein. The system may identify root causes of inefficiency using methods described herein, such as through automated and/or manual tagging. The system may make improvements to the efficiency of the process based on root causes identified for an identified bottleneck branch (i.e. in which one side of the branch is latent compared to another side of the branch). Exemplary embodiments may remove or reallocate wasted resources on a latent side of the bottleneck branch. Exemplary embodiments may then move up the process path to find a next critical branch or in the same branch in the workflow and iterate the process. Although an iterative process is shown and described, the entirety of the process can be observed and inefficiencies or reallocations observed and managed simultaneously.

Exemplary embodiments therefore may provide a lean technology approach by limiting what is monitored, or by not monitoring an entire process, or by focusing the analysis and assessment at strategic locations of the process. Exemplary embodiments may start with constraint branches and constraint workstations and then iteratively optimize both within the same branch and/or across branches. Exemplary embodiments may optimize workflows using the branches. Exemplary embodiments may also or alternatively be used to monitor desired or selective branches without first identifying a specific bottleneck. Performance at any given branch or process location, step, or point may therefore benefit from embodiments described herein. Exemplary embodiments may also be used to monitor an entire process and optimize an entire process in unison.

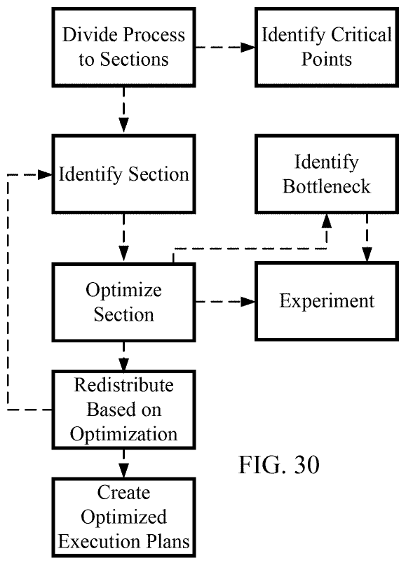

FIG. 30 illustrates an exemplary flow diagram for the method for improving a process according to embodiments described herein. First, the process line is divided into sections, then a section is identified, the identified section is optimized, and the identified section balanced or redistributed based on the optimization, and a new section is identified. The process is then repeated for the new section until the entire process line is optimized.

First, the process is divided into section. The division may be based on actions, machinery, process branches, etc. In an exemplary embodiment, critical points on the process line are identified. A critical point may be points on the line that have significance in process optimization. Exemplary critical points are shown and described herein. For example, exemplary crucial points may include branches occurring in a process line in which resources are coming together from different sources, an area of the line having sequencing constraints, and/or areas of the line experiencing significant slowdown. Slowdowns are understood to be any slow down that is beyond the actual working time or best case time for that given area or section of the line. Significant slowdowns are those slowdowns that are over a set amount, whether a time duration, percentage, etc. over the best case working time and/or those slowdowns contributing the most time to the overall process slowdown. The process line may be split into section based on identified critical points.

Exemplary embodiments of the method seek to optimize an identified section. A section may be identified based on the reverse chronology of the process section. For example, the last section of the process line may be identified to be optimized first. Other factors for prioritizing optimization may also be used. For example, the section contributing the most to the overall process delay may be identified and optimized.

Once a process section is identified, that section may be optimized according to embodiments described herein. In an exemplary embodiment, a process section may be optimized by building a work in process (WIP) at the start of the section and ensuring all other materials needed for all workstations as part of the section is available. Exemplary embodiments may include observing all of the resources required for the section including one or more workstations within the section.

Exemplary embodiments are described herein for optimizing sections. An exemplary embodiment for optimizing sections may include identifying bottlenecks and/or running an experiment. One or more bottlenecks may be identified to measure performance in each section. In an exemplary embodiment, a bottleneck may be identified by backups or time delays contributed to one or more workstations. Exemplary embodiments may include analyzing interruptions or process delays by measuring each station within the section of the bottleneck. Exemplary embodiments of the optimization may analyze line balancing and task balancing for the identified section. Exemplary embodiments of the experimentation and/or platform resources may be used to optimize the section.

Various line optimizations and/or iterations of experiments may be conducted. Once a final optimization is identified, the identified section may be redistributed or set up according to the optimization.

Once the identified section is optimized, then the next section may be identified. In an exemplary embodiment, the next section identified may be the next upstream section of the process line. In an exemplary embodiment, the next section identified may be the next priority based on delay contributions to the process line. One CIP ends, the process may be run through the upstream section to identify an upstream bottleneck section. The upstream bottleneck section may be identified as the pace setter section, i.e. that section that needs to be completed in order for other sections to perform their task. The optimization may then be performed for the next identified section according to embodiments described herein, such as those used for the first identified section. The optimization of an upstream section may be with or without activating the already optimized downstream section. Optimization according to embodiments described herein may be for various resource availability, including, without limitation, operator levels, operator skill sets, material levels, machine availability, components availability, resource availability, product mix, etc.

Exemplary embodiments described herein may be used to create process improvement plans for a given constraint. Essentially a process improvement playbook may be created for a given constraint. The process improvement plans may be included in the system in order to provide options for experiments and/or optimizations and/or automating process improvements according to embodiments described herein. After a process improvement plan is generated for each workstation, bottleneck, and/or process section, the process improvement plans (playbooks), may be used sequentially and/or in parallel based on time varying nature of the operator availability, operator characteristics, machine availability, resource availability, etc. across shifts and within shifts. Exemplary embodiments may therefore be used to receive inputs for the available resources, including, for example, the number of shift workers, the skill sets of the shift workers, the availability of machinery, etc. The system may thereafter provide an optimized execution plan to be executed for the process for that duration having the inputted resources. In an exemplary embodiment, the process may be optimized between shifts, when personnel changes, when machinery and/or work stations are added or removed, when resources become available for are not available, etc.

In an exemplary embodiment, the availability of resources and inputs to one or more workstations are used to set a base line for determining inefficiencies and/or delay contributions.

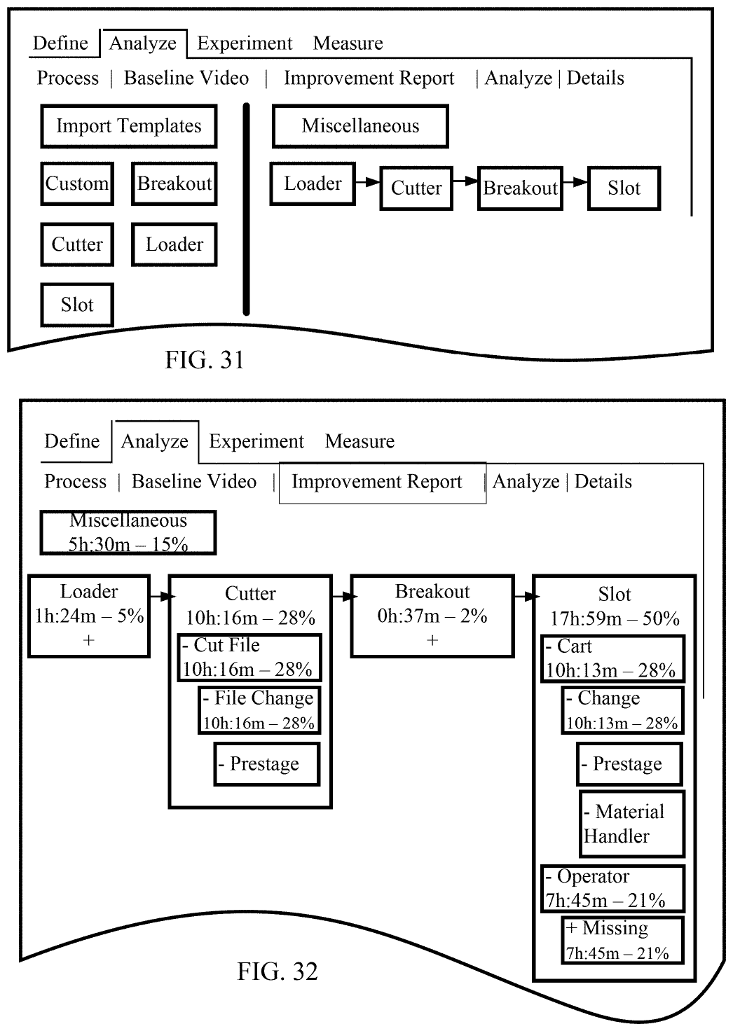

FIG. 31 illustrates an exemplary user interface for a process section that is being optimized within an exemplary method to improve a process line according to embodiments described herein. As illustrated, the system is configured to create the definition of the process being performed in the process section being improved. As illustrated, the exemplary section includes a glass cutter. The system may provide templates that provide steps and resources conventionally used with a glass cutter or created for a particular plant or process. The system may also suggest or provide steps and resources that may be used to define a new process. The user may make selections to define a process. As illustrated, the available options to define a process are provided on the left side of the user interface display, and through user inputs or selections, a process is defined on the right side of the user interface display. As illustrated, an exemplary glass cutting process including loading the glass into the cutter, cutting the glass, breaking the glass along the cut, and slotting the glass. The system may also be configured to permit a user to define the process step dependencies as described herein. The system may also and/or alternatively suggest or create dependencies based analysis of the data streams as described herein and/or based on prior process definitions used in the system. Suggestions or automatic selection of dependencies, the system may use the name of the workstation and/or process step, prior definitions of process steps, prior use of the system by a particular user, observations of the process by the system, other inputs and/or analysis described herein, and/or combinations thereof.

FIG. 32 illustrates an exemplary user interface according to embodiments of the system and method described herein for observing a report or effect of a process experiment. Based on the experiment set up as illustrated in FIG. 31, the system may be configured to attribute slow down allotments to the different defined steps of the process section. For example, as illustrated, loading requires 4% of the time, cutting requires 28%, breaking requires 2%, slotting requires 50%, and miscellaneous events account for the remaining 15%. The system may therefore be configured to provide a user interface for providing a breakdown of different routines that are attributable to the slowdown for a given action, or section of the process line.

In an exemplary embodiment, based on the observations of the process by the system, the system can provide information on the causes of the slow downs. The attributes of each of the process steps can be defined by a user and/or generated by the system. For example, as illustrated, the cutter requires loading a file in order for the cutter to perform the cut on the glass. The slotting requires a cart to move the glass, and an operator to perform the slotting. The system may be configured to provide, receive, and/or display different subroutines of a routine and attribute an allotted portion of the slow down for each of the subroutines. For example, as illustrated, the loading of the file attributes to the entire slow down of the cutter, while the slotting splits the delay between the use of the cart and the operator. As illustrated, the delays in the slotting occurs because inefficiencies of retrieving and using the cart, and the operator simply missing from their station. The routines and/or subroutines may be the root causes as described herein for determining an inefficiency event.

In an exemplary embodiment, once the root causes of an inefficiency are determined, the system may provide suggestions for improving the inefficiency. For example, the system may determine improvements for the cart by setting up a prestaging area that provides sufficient carts for use without an operator having to leave their station and retrieve a cart. Another alternative may be to use additional material handling equipment so that an operator is not using a cart to transport materials. The user may thereafter make selections based on their operations, and available space, budget, etc. in order to improve that process.

Exemplary embodiments may use color coded or other visual indicators for distinguishing process steps, root causes, an/or suggested solutions to further distinguish attributes of the system. In an exemplary embodiment, the system may receive or create steps within a process. Each step may include a workstation, such as an action by a user, and/or use of a machine. Each step may also or alternatively include any or all dependencies associated with the step. The dependencies may include any combination of resources and/or action necessary to perform the step. For example, as illustrated with respect to the slotter, the step requires a cart to remove the glass from the station and an operator in order to perform the action on the glass. An inefficiency in obtaining or using a cart or in the operator performing the task or not performing the task can lead to inefficiencies in that process step. Each dependency may be identified in a first color. Each dependency may then be divided into subroutines or actions that contributed to an inefficient, i.e. a root cause. Each root cause may be identified in a second color. Each root cause may be displayed as a subset of the workstation. Each root cause may then have one or more solutions for improving the root cause. Each improvement may be identified in a third color and illustrated as a subset of the root cause. Exemplary embodiments of the user interface may permit each set and/or subset to be expanded or collapsed to improve information presentation. In other words, each step, workstation, root cause, etc. may be selected and expanded to see additional information and/or selected and collapsed to remove information for easier visualization of the process.

Exemplary embodiments of the system may be configured to provide clear root cause presentations of information and associated delays. Exemplary embodiments may also provide one or more solutions or suggestions to the root cause. The system may be configured to run simulations running the suggestions and predict improvements in the process based on the selected changes. Operators may therefore make informed decisions on investments into additional available resources and the return achieved in the process improvements based on those investments.

Exemplary embodiments described herein may be used to capture and/or analyze a process line as an entire process. Depending on a workstation, activity name, utilized resource, and/or a combination thereof, the system may be configured to automatically recommend dependencies, and/or identify potential slowdowns due to dependencies, and/or provide potential improvements thereto.

Exemplary embodiments described herein may permit episodes to be identified for root causes. The system may be configured to recommend root cause tags that may be assigned to work stations, resources, process steps, identified inefficiency events, etc. Exemplary embodiments described herein may include automatic tagging of events and/or root causes, and/or may permit manual tagging, and/or may permit a user to accept and/or change a recommended or automatically assigned tag.

Exemplary embodiments described herein may be configured to automatically generate improvement reports. Embodiments of these reports may provide process steps of a process line and/or sections thereof, including, for example workstations, machinery, stations of an operator, etc. Exemplary embodiments may take these process steps to provide subdivisions of actions, resources, events, etc. that may isolate, segregate, rank order and prioritize resources, actions, etc. of inefficiencies. An exemplary report may include a process flow block based improvement report that isolates the workstation, dependency and slowdown causing the process inefficiencies (i.e. root cause), as described herein. Exemplary embodiments may be configured to attribute a time and/or percentage of the slow down to one or more root causes, and/or dependency according to embodiments described herein.

Exemplary embodiments may provide visual indications of activities or branches that are under producing verses over producing. Such visualization and assessment of activities may be in real time and dynamic such that embodiments described herein can provide feedback to personnel and can redirect activities in real time in response to a dynamic situation. For example, visual cues may be provided on the process floor such that workers may receive the cue (for example, using automated Andon lights) and realign priorities in order to improve overall efficiencies of the process. Benefits of resource reallocation may therefore be achieved without additional supervision. Exemplary embodiments may therefore be used for dynamic workflow optimization and/or line balancing.

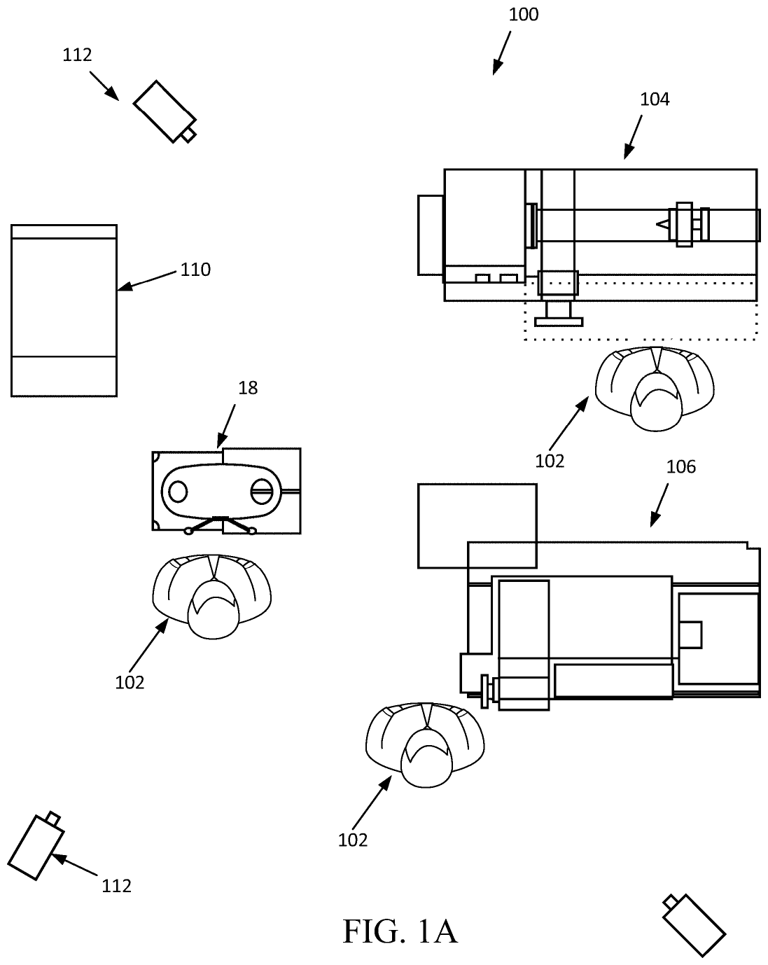

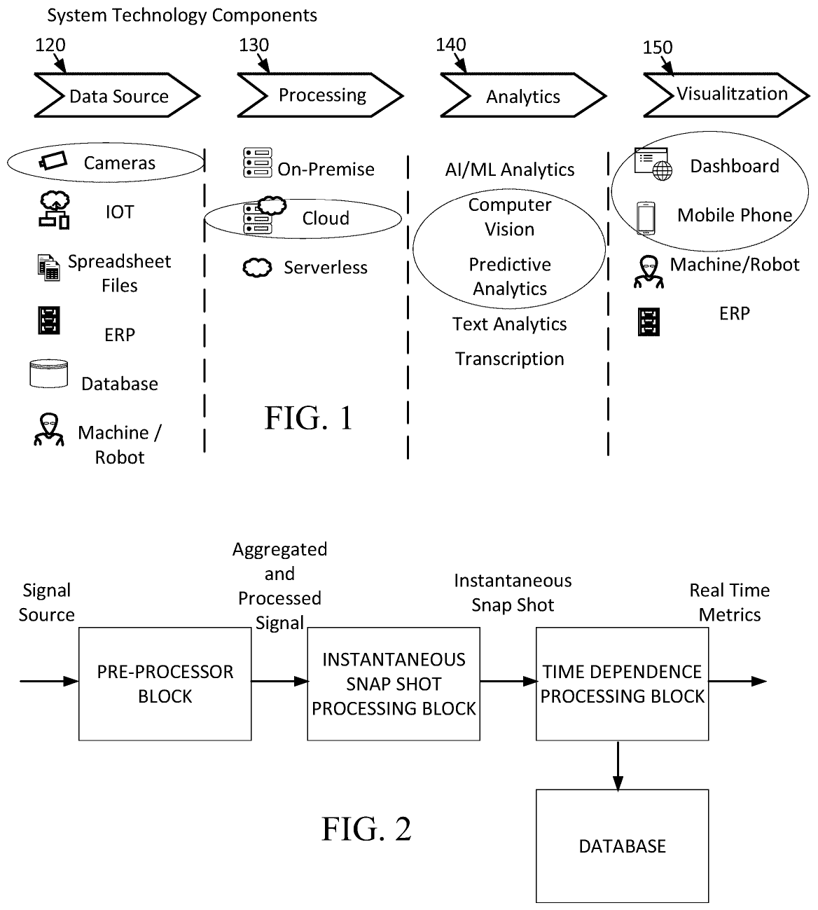

FIG. 1A illustrates an exemplary process floor 100 with a plurality of workers 102 running a plurality of machines 104, 106, 108. An exemplary process may be in a creation of a component that is taken from different work stations to be machined at the different machines. An exemplary process may be in a creation of a component that is formed from different parts that are created from different machined processes. The process path may include a different combination of parts, machines, and personnel coming together to perform individual steps to complete the process. Each of the intersections of part(s), machine(s), and/or personnel may create a branch in the process. At each branch, there is a potential for one input of the branch to be more inefficient than another input such that one side becomes latent as compared against another. For example, each of machines 104, 106, and 108 may have its own personnel and have separate parts running simultaneously. However, the part at the first machine 104 may be ready before the next machine is finished with its part, such that the part leaving the first machine 104 becomes latent as it waits for access to the second machine 106. Latencies may also arise if supplies must be retrieved, such as from a supply cabinet 110, while a machine 108 remains unused. Latencies may also arise when different component parts come together and one part is ready before another before the two or more parts can be assembled. A process path will have many source of root causes to an inefficiency from machine up/down time, personnel delays, supply chain, etc. The root causes may be systemic, such that the root cause is from the design of the process path. For example, the machine process at a first machine may simply take less time than a process time at a later machine. The root causes may also be non-systemic in that they arise based on unplanned activity. For example, a machine may break, a worker at a given machine may get distracted or be inefficient. The root cause may be dynamic in that it changes and is variable over time.

Exemplary embodiments may be used to view, show, and/or realize inefficiencies within a process. Exemplary embodiments may analyze a system at a process level including all or a subset of resources. For example, the system may monitor the use of people, machines, tools, parts, etc. The system may be configured to determine that a resource is underutilized such as when a machine is not in use, a person is not at a station or desired work location, a part is backed up or waiting to be processed at the next step, etc.

Conventionally, to detect root causes of a process inefficiency, a person or persons would observe the process for a period of time. The observation is generally based on one or more presumptions about the root cause as any number of people cannot observe and comprehend the entirety of the process to determine a root cause without first focusing on a subset of likely candidates. Even computer systems observing an entire process path would have to manage a large amount of data in order to analyze and determine a root cause without using a likely subset. Such processing power requires substantial computer power, bandwidth, hardware, and expense.

As seen in FIG. 1A, exemplary embodiments of the system described herein include an automated, continuous monitoring and data capture solution comprising one or more cameras 112. The cameras may define a field of view that captures one or more branches of a process path. For example, a camera may observe one or more machines, personnel, stations, supplies, etc. The system may also include one or more focused cameras on a narrower field of view, such as a process step. The system may also include one or more additional sensors.

Exemplary embodiments described herein may include novel analysis of the signals received from a signal source, such as a camera, in order to reduce the processing requirements on the system, provide real time analysis and/or feedback on the process, and/or identify a root cause of an inefficiency within the process. Exemplary embodiments described herein are directed at determining root causes of inefficiencies in a process path. However, exemplary embodiments are not so limited. For example, exemplary embodiments may also be used for assessing, tracking, and/or recording for quality assurance or safety compliance. Other applications may also include inventory management, supply chain management, and/or personnel assessment.

Although embodiments described herein may be optimized for real time analysis and metrics of performance, exemplary embodiments may also be used to analyze historic data, information over time, etc. Exemplary embodiments may therefore provide real time and non-real time analysis and metrics of process performance. Exemplary embodiments may provide automated, semi-automated, and manual root cause identification. Exemplary embodiments described herein may therefore be used in quality control, safety, inventory management, supply chain, etc.

FIG. 1 illustrates the technology components of an exemplary system that may perform the functions described herein including a highly customizable platform for rapid scalability across a business for any application described herein or other application that would be apparent to a person of skill in the art. Any one or more system components may be used in any combination. System components may be duplicated, integrated, added, removed, or otherwise configured to achieve the desired objectives.

As seen in FIG. 1, the system and method may include one or more data sources 120, Processing Blocks 130, analytics 140, and visualization system and methods 150. The data sources 120 provide signal sources for the inputs to the system to consider and provide a representation or result to a user through the visualization 150 or user interface display. The processing 130 and analytics 140 permit the functions described herein (for example, among others, asset effectiveness, issue identification and prioritization, workflow optimization, monitoring, estimation, verification, compliance, presentation, identification) for the applications described herein. Such application may include, but are not limited to, manufacturing, quality control, supply chain management, and safety compliance.

The data sources 120 described herein are exemplary only, and may include any component for generating or receiving one or more data inputs that can be analysed and/or observed over time according to embodiments described herein. For example, exemplary data sources may include cameras, IoT, digital devices, user inputs, software inputs spreadsheet or other information sources, Enterprise Resource Planning (ERP) software, database(s), other electronic or digital system, sensors, detectors, etc.

In an exemplary embodiment, the sensor may include a barcode scanner. The barcode scanner may be integrated into the camera system such that an object with a barcode on it, used to identify an object may be recognized in the system. The barcode scanner may also be a separate sensor. In this case, a component part or other object moving through the process may be identified with a barcode. Users at individual stations or at locations within the facility or along the process may have barcode scanners configured to scan the barcode of an object as it moves through that location. The barcode scanner may be used, for example, as a time stamp of when an object is received and/or leaves a location. For example, a technician may receive a part as part of a larger process and use a barcode scanner to scan a barcode associated with the object when it is received at the technician's location. The technician then performs a function at their station on the object, and scans the barcode again when the object leaves their station. The system may use these time stamps to detect and/or determine events according to embodiments described herein. Other sensors, such as radio frequency identification, sonar, radio frequency, infrared, Near Field Communication (NFC), Bluetooth, etc. may also or alternatively be used to identify, scan, and/or time stamp objects and/or events according to embodiments described herein. Exemplary embodiments may incorporate one or more independent sensor systems, such as a barcode scanning system. Exemplary embodiments may use the one or more sensor systems to provide time stamps of events that is then utilized by the system to analyze the given process and/or provide information for visualizing and/or detecting events according to embodiments described herein.

Exemplary embodiments may be used in combination with the camera and sensor systems described herein. For example, a barcode may be scanned at a first location and the camera system may be used to determine when the component part leaves the station. The barcode (or other sensor) scan may be used as an input to the system to focus a fidelity as described herein for analysis. For example, an input from a sensor, such as a scan of a part may be used to specify portions of a camera frame to focus on and/or analyze and/or to predict the presence or absence of a part for recognition and/or to set a state condition of the system and/or to use high level location and/or low level location settings of the camera configuration (pan, tilt, zoom, and/or a select subset of camera feed combinations for processing).

The processing 130 may be performed on premises, may be through a network or cloud, may be serverless, may be distributed across one or more digital devices within the system, and combinations thereof. For example, some analytics (including pre-processing) may be performed at the data source, while other analytics may be performed at a remote location on a remote processing unit or distributed among one or more processing units. The processing units may be dedicated machines or incorporated into one or more other system components. The system may include one or more processor(s) and memor(y/ies), where the memor(y/ies) include non-transitory machine readable medium that when executed by the one or more processor(s) perform the functions described herein.

The system may include visualization 150 for providing an output to a user in one or more ways. For example, the system may be configured to generate a dashboard for display on a visual display. The dashboard may present information to the user, retrieve or display information from the data sources, identify the results of the analytics including, but not limited to, asset effectiveness, issue identification and prioritization, workflow optimization, monitoring, estimation, verification, compliance, presentation, identification, and simulation of what-if scenarios. The system may output information from the analytics into one or more data sources, such as a database, record, another software program, or management system. The system may provide other outputs to a user, such as visual, audial, or otherwise. For example, when an issue is identified or when resources are not optimized, a notice may be sent through visual or audial cues to reposition resources, as described herein or otherwise understood by a person of skill in the art. Any combination of cues (such as visual cues and/or audio cues) may be used. Exemplary embodiments may include system control features such that machines may be shut down to indicate the movement of personnel from one location to another. Other indicators, such as signs, display screens, lights, etc. may also or additionally be used.

Exemplary system and methods described herein may include configurable algorithms that may combine deep learning, signal processing, and combinations of other machine learning, artificial intelligence, or analysis methodologies. The analytics 140 may include artificial intelligence (AI), machine learning (ML), computer vision, predictive analytics, text analytics, transcription, and combinations thereof. Exemplary embodiments may provide accurate results even under very low image/signal resolution. Exemplary embodiments may be customizable to customer's needs, scalable, and affordable.

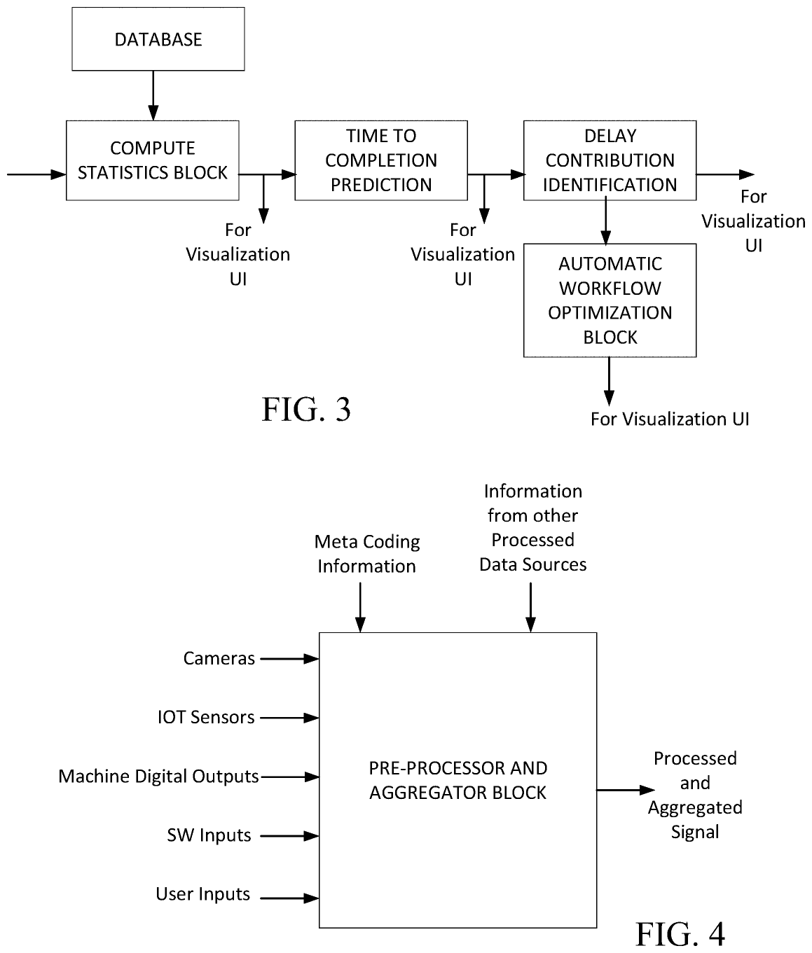

FIG. 2 illustrate exemplary pre-processor and aggregation algorithms and details according to embodiments described herein. FIGS. 4-7C illustrate exemplary processes describing the pre-processor and aggregation algorithms described in FIG. 2. FIG. 3 illustrates the exemplary analytics according to embodiments described herein to generate the features and benefits described herein.

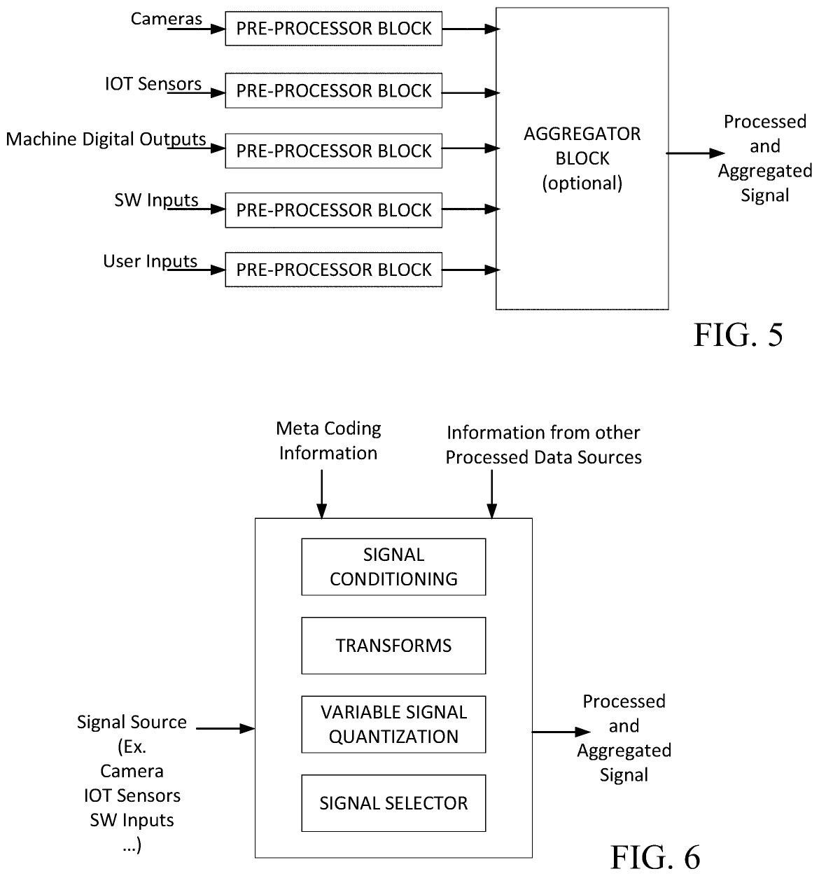

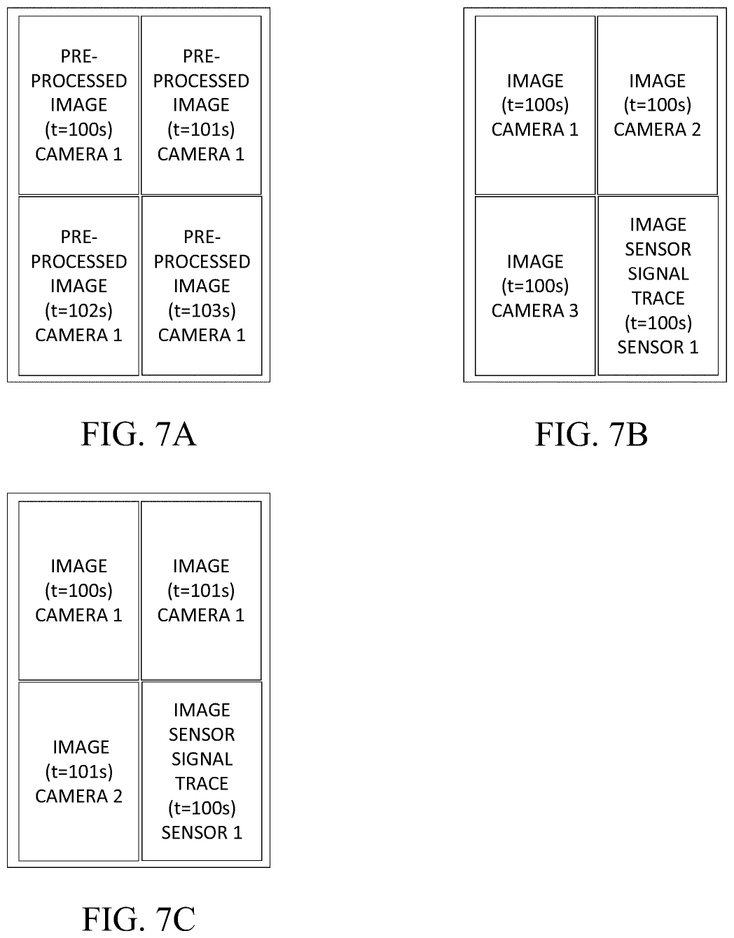

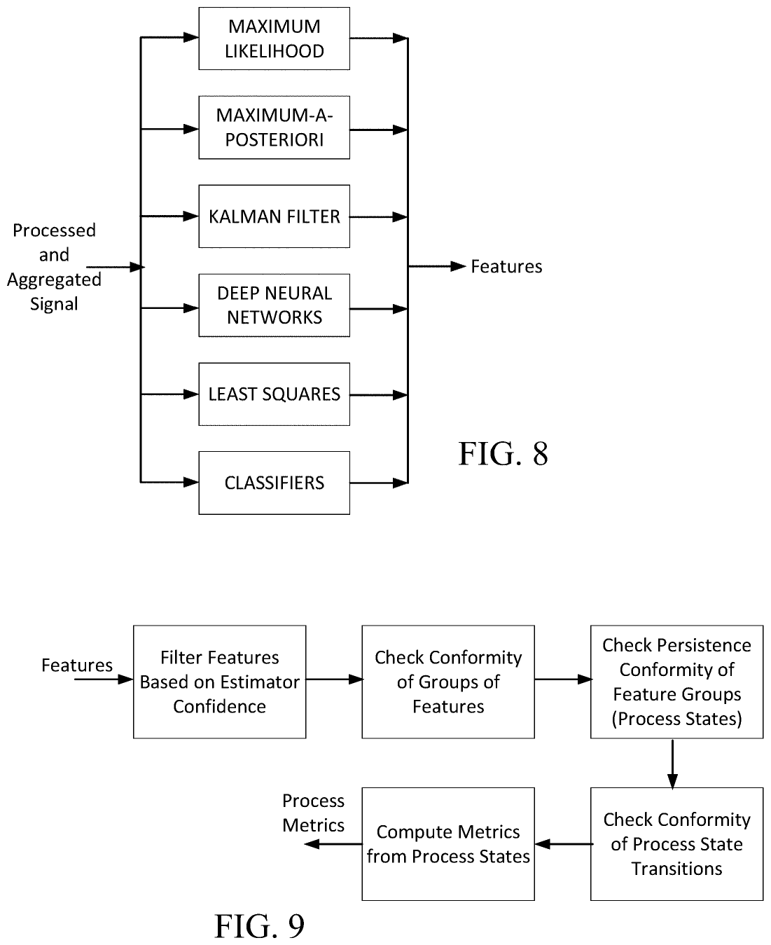

FIG. 2 illustrates an exemplary pre-processing and aggregation according to embodiments described herein. The pre-processing and aggregation algorithms may receive signals from a data source, pre-process the received signals, aggregate the processed signals, process the aggregated pre-processed signals with an instantaneous snap shot processing algorithm to generate an instantaneous snap shot that may then be processed for time or any causal dependence for a real time metric for observation and analysis. The pre-processed snap shot may originate from one or more signals from various sources (data sources) (either individually or in combination/aggregation). The Pre-Processor Block may be used to adaptively vary fidelity, processing size, identify areas or portions of signals for observation and analysis, remove areas or portions of signals not of observation, sampling, filtering, etc. FIG. 4 illustrates exemplary Process Block of the Pre-Processing Block of FIG. 2. FIGS. 5-6 illustrates exemplary Process Blocks of the pre-processing and aggregation. FIGS. 7A-7C illustrate exemplary options of aggregated and processed data signals from camera images. The aggregated and processed signals may be input into an Instantaneous Snap Shot Processing Block that estimates various features or state attributes. The features or state attributes can be, for example, object position (in the case of images) or signatures in signal waveforms associated with IoT sensors. These features may be generated using many Processing Blocks like Deep Neural Nets (DNN) (for example Region based Convolution Neural Nets—RCNN), Transforms (DCT, FFT, etc.) or adaptive signal processing algorithms like Kalman estimators. FIG. 8 illustrates an exemplary Process Block of the Instantaneous Snap shot Processing Estimator Block of FIG. 2. The features and attributes generated by the Instantaneous Processing Block (i.e. Instantaneous Snap Shot of FIG. 2) are then input to the State Based Time-Dependence Processing Block. The State Based Time-Dependent Processing Block may be programmed to measure and track any combination of the following: conformity of features to specific values/value ranges (e.g. location of an object or a group of objects within a certain region of the image, signal features like derivatives within certain bounds); conformity of persistence of such features indicating a certain process state; conformity of specific transition of such persistent process states from one to the other; metrics related to such transitions like duration between specific transitions and number of transitions. Additionally, in another embodiment, these features and attributes from the Instantaneous Processing Block are then fed into Sequence Modelling Algorithm Blocks. This may be performed using Long Short Term Memory (LSTM), Gated Recurrent Unit (GRU), etc. FIG. 9 illustrates an exemplary Process Block of the State Based Time-Dependence Processing Block of FIG. 2.

Exemplary embodiments may include processing various signal sources. The signal sources may be aggregated during or before processing. The processing may include adaptive filtering and/or noise reduction. The processing may include adaptive fidelity changes. The processing may include adaptive regional focus based on results from across a plurality of cameras and/or across frames of the same camera, across regions of the same frame, or a combination thereof. The processing may include state based analysis, and/or state transitions to focus the analysis of the data streams.

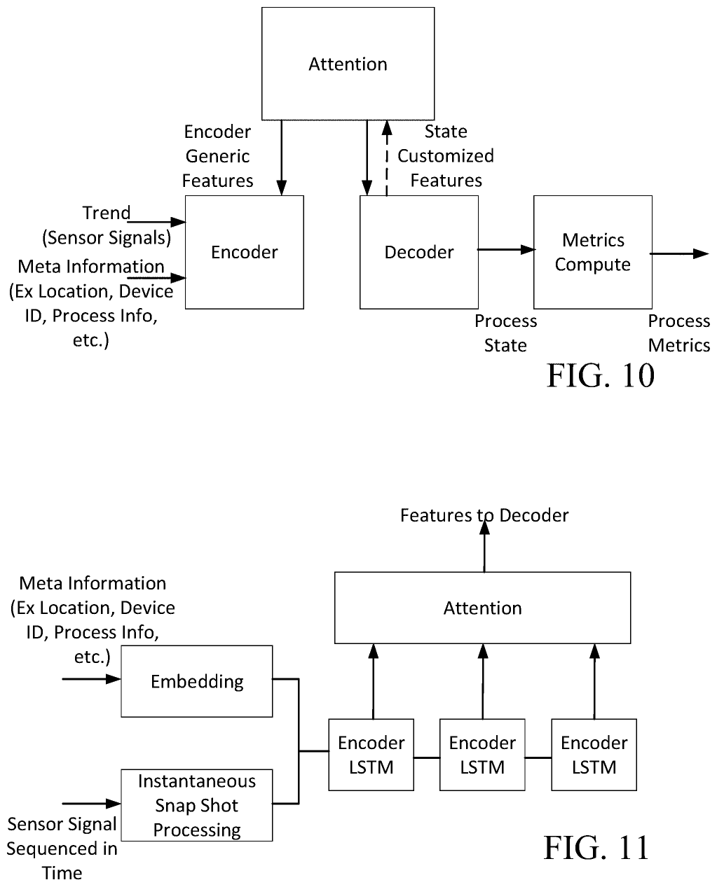

FIG. 10 provides an exemplary sequence based neural net model to compute process metrics according to embodiments described herein. The neural net model to compute process metrics may be used in place of the block diagram of FIG. 2 or in combination therewith. Time sequenced signals from various sources may be fed as input to an Encoder Block (optionally) along with meta information like location of the sensor, process being monitored etc. to the model. The encoder processes the features across a certain time range and generates decoder state independent generic features. The attention module uses the information from the generic features from the encoder and the historical-state information from the decoder to generate a customized state feature information to be used by the decoder for predicting future decoder states. The decoder may iteratively compute the process states based on previously decoded states and the customized features from the Attention model. The Metrics Compute Block computes process metrics from the process states.

As illustrated in FIG. 11, time sequence of signals from various sources may be fed as input to the Instantaneous Snap Shot Processing Block which generates snap shot specific features for each time instance. Meta information like location of the sensor, process being monitored, etc. may first be embedded into higher dimensional vectors and then fed to an encoder. The data is then aggregated and fed to a family of Recurrent Neural Network (RNN) like LSTM, GRUs, etc. The LSTM may spread the processing of the snap shots for each time stamp and then generate an effective vector. The effective vector may then be combined with information from historical decoder states to generate a customized set of features that help with the decoding of further states as part of the decoder computations.

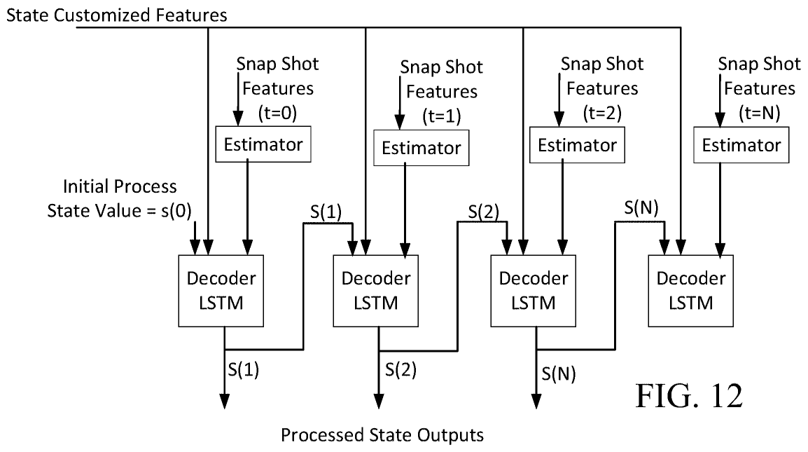

As seen in FIG. 12, for each process state instance, a State Customized Features along with previous decoder state may be fed into a decoder LSTM block unit, which in turn may generate future process states. Optionally each decoder unit estimation of next state can also be augmented with instantaneous snap shot information corresponding to that time instance, including any meta information. At any given instance, the computed process states may then be fed back to the Attention Block that uses this state information and generates customized features for the next decoder state computation. The computed process states may then be input to the Compute Metric Block to generate the Process Metrics. These process metrics may also be sent to the Visualization and Notification modules for display. Additionally, Process Metrics are also fed to the data base block for storage.

FIG. 3 illustrates the exemplary analytics according to embodiments described herein to generate the features and benefits described herein. The computed Process Metrics and other meta information may be captured in a data base for the purpose of displaying and analyzing trends, compute statistics etc. The compute statics block may be used to measure and compute desired statistical trends or other metrics. For example, data from the database may be extracted to measure statistical trends and other metrics like probability density functions of time to completion of a specific activity, percentage of time a resource (e.g. worker) spends at a working location, heat maps of movement resources, etc. Given the individual's activity's time to completion statistics, the Time to Completion Prediction Block calculates the time to complete an entire work flow consisting of many individual activities. The Delay Contribution Identification Block may compute the delay cost contributions for each block in the entire workflow. The final delay cost computations at the end of the workflow may be propagated for each block upstream in the workflow depending on the contribution to that block to the downstream delay. Based on the cost contribution from each block, the Automated Workflow Optimization Block may rearrange the priorities of resources so as to minimize the total delay cost contribution to the workflow.

Exemplary embodiments described herein may provide metrics for a user. For example, time to completion for a workstation and/or an entire process or line may be provided. As an example, the delay contributions of a block may be provided. As an example, resource utilization may be provided, such as an in use time or down time of a given machine, person, component part, etc. Exemplary embodiments may provide optimized sequences and/or process steps. Exemplary embodiments may permit a use to redistribute resources and/or add and/or remove resources and run simulations based on history or real time data. For example, if a component part on one line coming into a branch gets backed up and delayed by the capacity or through put limitations of a machine and/or person at that branch point, the system may simulate adding another resource (such as another machine and/or person) and/or may simulate removing one or more resources from the overproducing line and/or moving resources from one portion to another. The system may use historic information about machine and/or personnel throughput for a given activity in order to estimate the effects on the process.

Exemplary embodiments described herein may be used for real time notifications. Notifications may be displayed to an operator (resource) to generate improvement at the time improvement is desired, and/or may wait until the end or beginning of the shift for that operator to improve their skills for the next iteration of that resource (operator). Exemplary embodiments may provide notifications of inefficiency events along with root causes and/or associated videos of the inefficiency events and capturing the root causes contributing to the inefficiency. For example, if an operator is away from a station that causes a delay, the operator may receive a notification of the time away from their station, videos showing the absence, and/or videos showing where they are, and/or explanations of the inefficiency event, associated delays, root causes, possible improvement suggestions, etc. The same and/or similar information may be provided through an alert and/or user interface of the system to the process line administrator. The administrator may be alerted so that the administrator can address the issues with the operator. In some cases, the operator, may, for example, be away from their station because of the design of the process flow—for example, the operator may have to retrieve materials. The process line administrator, when receiving the alert may thereafter make decisions on process improvements that are related to the process line and not the operator themselves.

Exemplary embodiments of the real time notifications permitted herein may be used to keep process throughput targets. For example, the system may identify inefficiencies that may effect the throughput targets of a process line. The system may provide notices to a system administrator if the process throughput estimates diminish by a certain amount and/or if the process through targets may not be achieved. The system may provide some notice threshold before the process target thresholds are no longer achievable so that corrections may be made before the targets cannot be met.

Exemplary embodiments of the systems and methods described herein may permit process line administrators to manage by exception. Exemplary embodiments may therefore permit a manager and/or operator to be informed and/or discover inefficiencies and make corrections thereto when they occur and/or when they are discovered. The system process operators and or process administrators may therefore focus their attention on areas causing inefficiencies instead of watching an entire process line in which the majority of the process line is running correctly, which may permit them to miss the inefficiency events. The system may be configured to identify specific inefficiency events, such as operators operating a workstation incorrectly, operators away from their workstations when they should not be, operator inefficiency times exceeding a threshold, machine operation being underutilized, machine operation errors, machine maintenance, broken and/or inoperable machines, etc.

Exemplary embodiments described herein may permit the use of process metrics at branch locations of a process line and/or at bottleneck workstations. These areas may provide key metrics and/or line improvement suggestions in real time to improve the inefficiencies at prioritized locations of the process line.

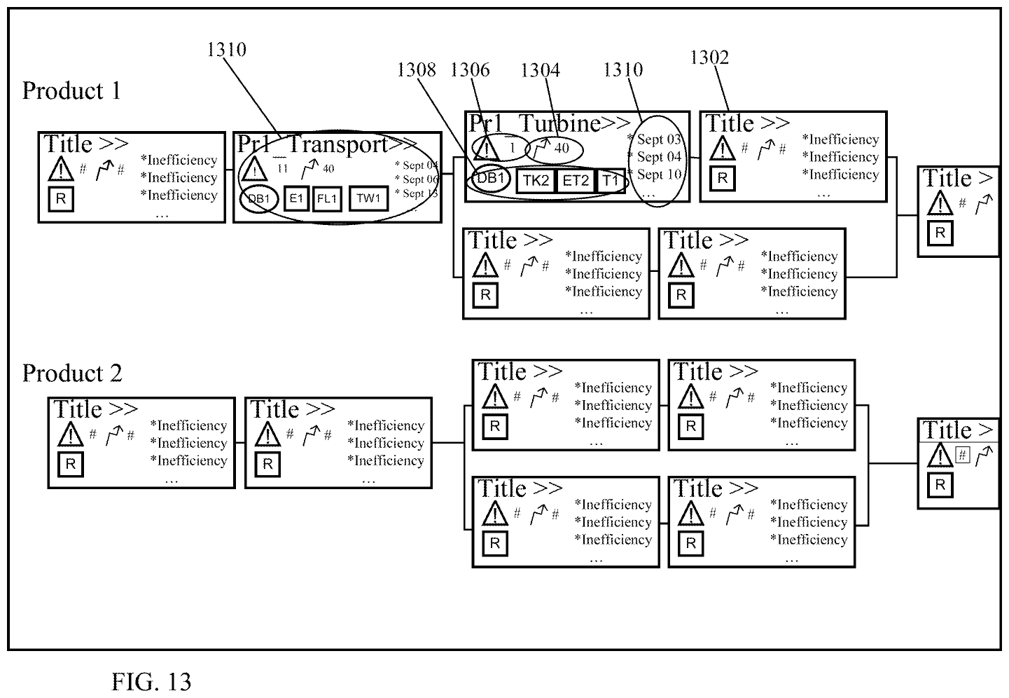

FIGS. 13-16 illustrate exemplary displays that may be used to visualize a workflow optimization.

FIG. 13 illustrates the process steps for two products through a production line. Each process step is represented by its own Process Block 1302. FIG. 13 provides a block diagram view of the process flow. A Process Block 1302 may provide information to a user. For example, the resources 1308 used for the process step may be identified. Resources may include personnel, equipment, materials, or other identified metric. The time to completion 1310 may also be estimated and displayed. The probabilistic estimate of the time to complete an activity (e.g. manufacturing job), may be based on historical data. Other information may include progress percentage 1304, delay costs attributed to the process step 1306, or an indication of a process delay or inefficiency 1310, such as through color identification. The process percentage 1304 may measure a process efficiency relative to the process's historical performance of time to completion of activities. The indication of a process delay or inefficiency 1310 may identify the bottleneck resources causing the delay for the given activity. The system may quantify the contribution of each resource to that bottleneck delay. The system may provide visual indication of the activity/activities that are under producing verses over producing. A Process Block may also capture inventory status and may predict time to exhaust stock of a specific type of inventory.

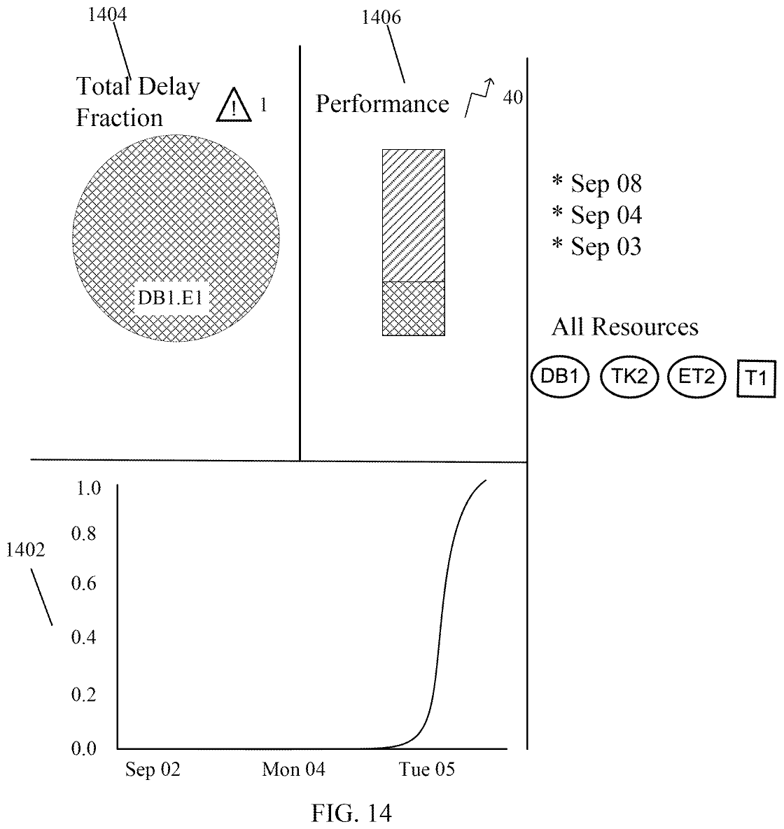

FIG. 14 illustrates metrics for a given process step, which may be displayed if a user selects onto of the process steps from FIG. 13, for example. The probability of activity completion 1402 may be predicted for the process step. The resources or metrics attributing the delay may be displayed as a total delay fraction 1404 and corresponding visualization, such as a pie chart of the root causes contributing to a delay.

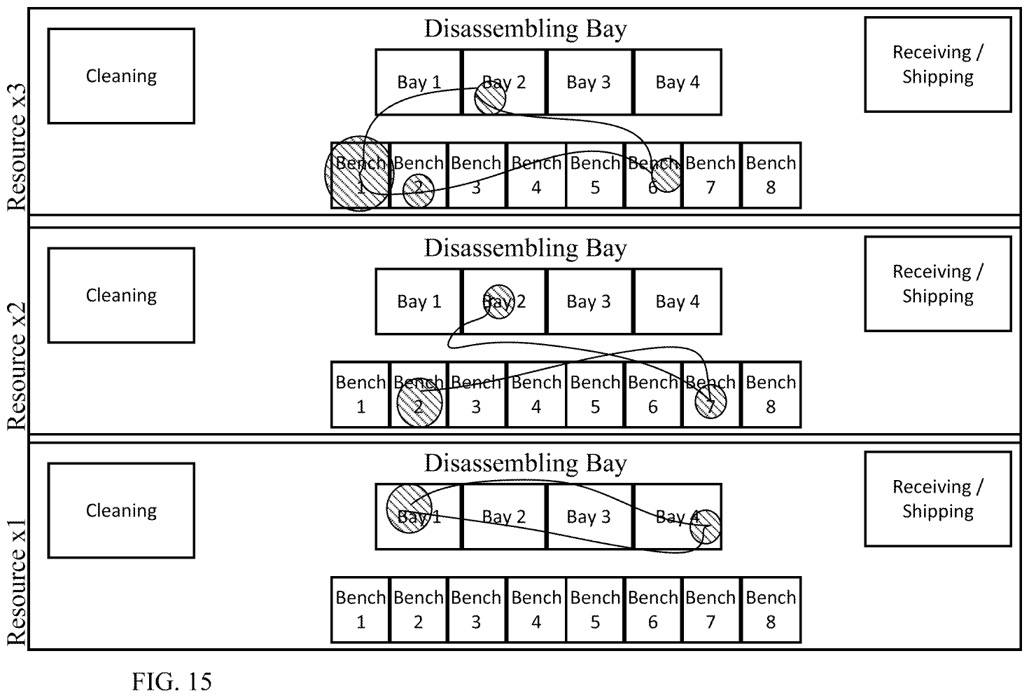

FIG. 15 illustrates an exemplary visualization in which resources are identified in a heat map indicating their location during the processing steps. The heat map may be for tracking a component part, personnel, or other resource through the process steps. The heat map may provide visualization of resource allocation, delays, etc. As illustrated in FIG. 15. An efficiency 1502 of a given resource can be calculated and displayed. The measure of efficiency for each resource may be based on the time spent on/in the required zones.

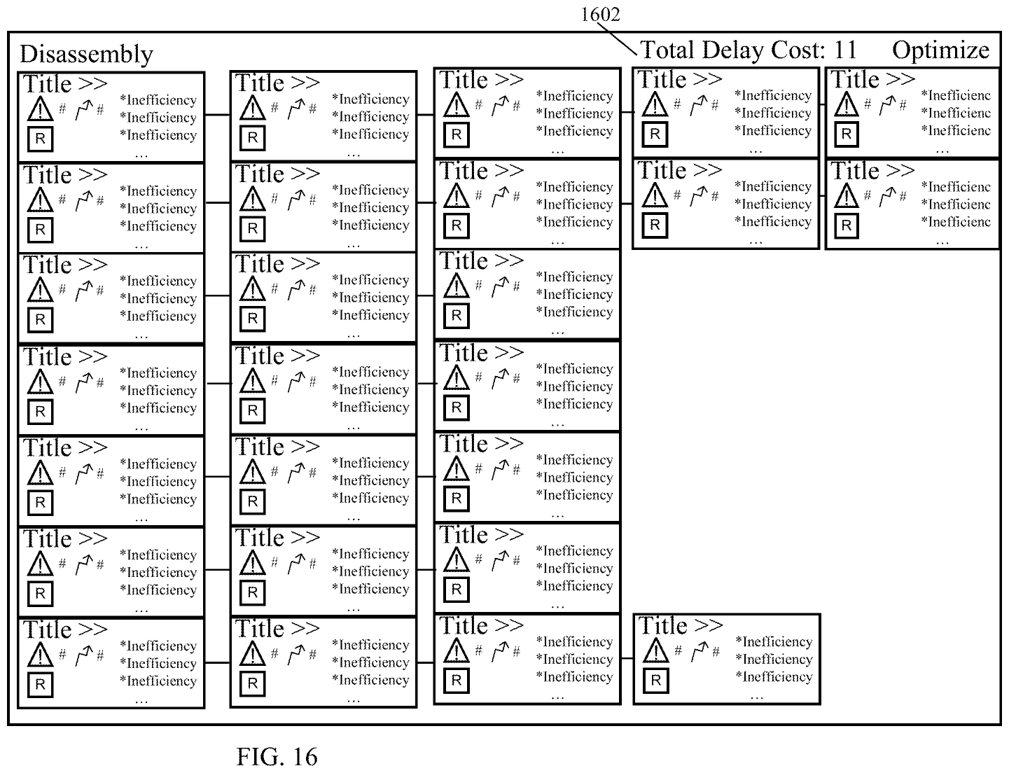

FIG. 16 provides an exemplary department specific visualization. As illustrated, the system may also provide a feature to optimize the sequence of activities (e.g. manufacturing jobs), in addition to the priorities of resources, based on bottleneck contributions. The sequencing and prioritization may be changed adaptively based on inputs and updates from various data sources. The department specific view or group specific view of optimized workflow provides a visualization of various resources involved in the department.

Exemplary embodiments may be used to simulate the effects of changes to workflow (including user defined ones). Some examples of changes may include simulating the effect of reduction in root causes of inefficiencies identified using the methods described above

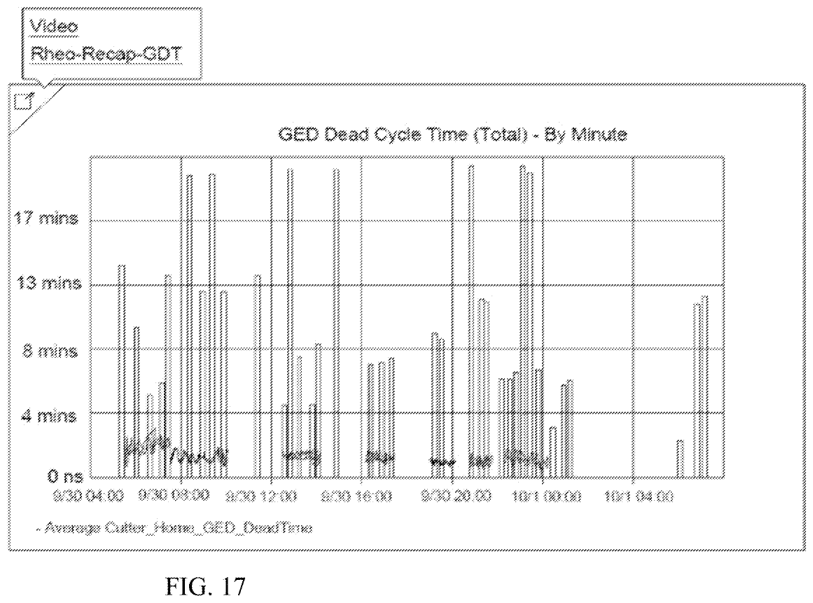

FIGS. 17-21 illustrate exemplary visualizations for recap review by a manager or other user. Exemplary embodiments of a visualization system includes a dashboard with various representations of individual or aggregated metrics. For example, as illustrated in FIG. 17, one or more metrics may be provided and plotted over time. The dashboard may be configured to permit a user to zoom in to a specific section of the plot. The user may be able to view the data from the data source corresponding to the represented metric. For example, the data source may be from a video recording from a camera. The user may select a specific time and see the video footage associated with the camera feed at that time. Exemplary embodiments may include dashboard zoom features to lead and/or permit a user to navigate through videos in desired durations or time scopes. Exemplary embodiments may include augmented dashboards with video feeds.

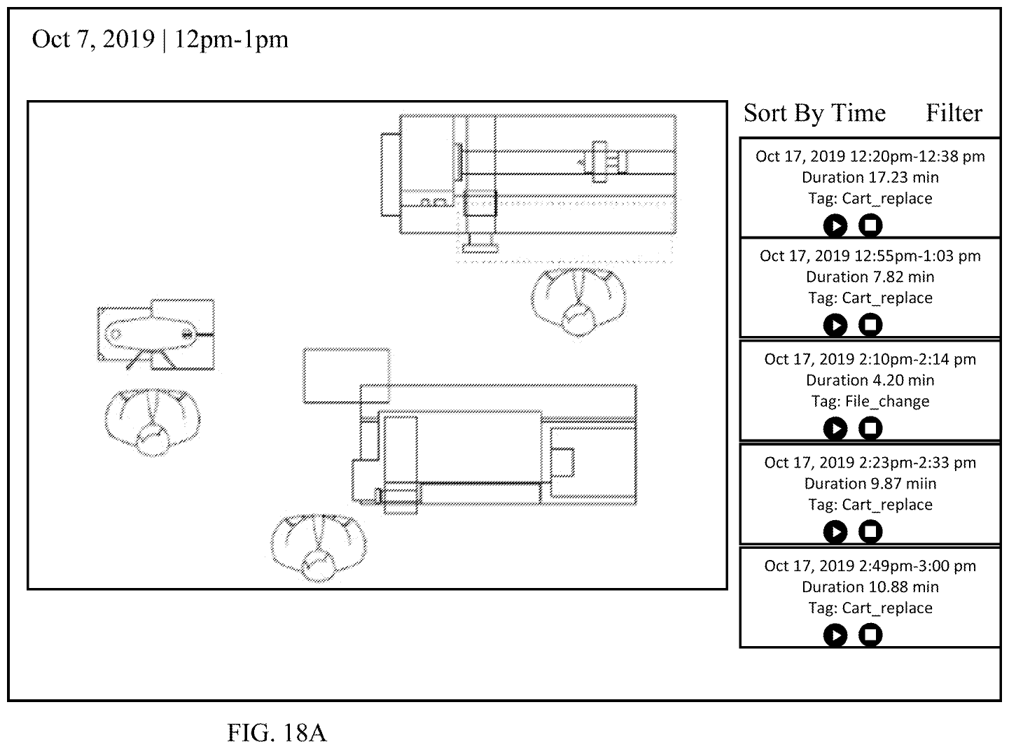

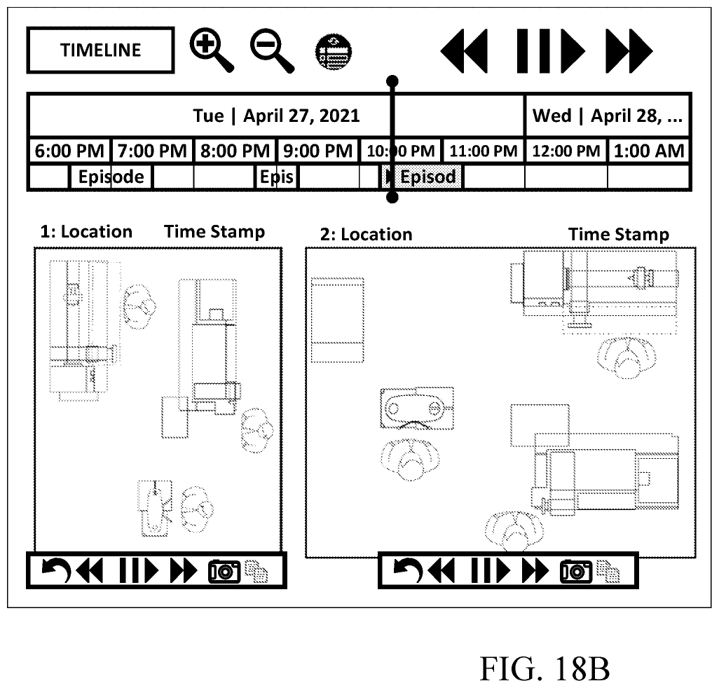

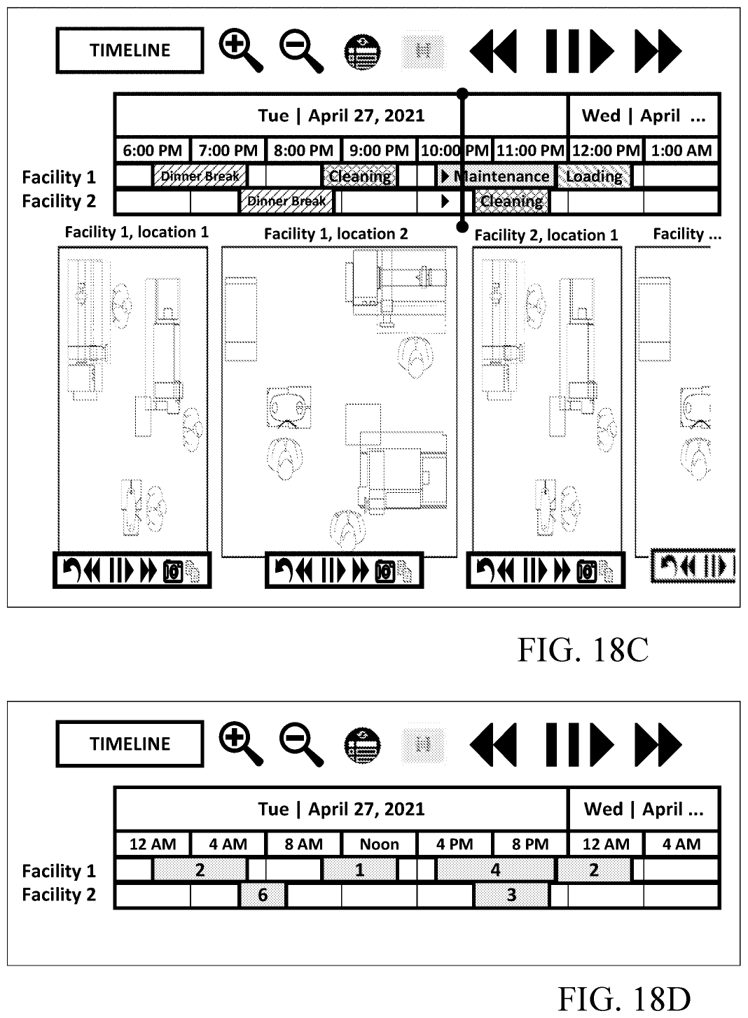

As illustrated in FIGS. 18A-18B, exemplary embodiments may automatically identify epochs of critical events or any event in the process (such as those identified with a metric above or below a threshold, or when processing time exceeds a threshold). FIG. 18A uses the image of FIG. 1 to illustrate a camera feed of an area for sake of illustration. An actual camera feed may show the perspective view of a process area in a specific band or detection method (such as audio, visible light, temperature, etc.). As illustrated, the camera feed is provided on the left of the image, and a list of critical events are identified sequentially on the right of the image. A user may play the events sequentially or may click through on given events to see the corresponding video images associated with the events. The user may also use the interface to tag or classify the actions that are occurring in the given event. For example, as described herein a cause of the critical event may be identified by the user. The system and/or user may associated tags with critical events, and/or associated with periods of time of the sensor feeds. For example, tags may associated with an hour, ½ hour, ¼ hour increments of time on the process observed and/or captured by the system. Tags may be associated with what is occurring in the process, a state of a resource, a root cause of a critical event, a description of a critical event, and/or combinations thereof. These tags may be used to search for specific events and/or may be used to train the system to automatically identify other events.

FIG. 18B illustrates an exemplary embodiment in which the epochs of critical events are illustrated on a timeline. As shown, a timeline is provided at a top portion of the screen. The occurrence of an event (identified as “Episode” in the illustration) are provided as icons on the timeline. A user may then click on any event (or any portion of the timeline) and initiate one or more videos associated with the selected time. As illustrated, two cameras are selected that correspond to images that contributed to a given “episode”. The system may automatically select one or more camera feeds that may identify or assist the viewer in identifying or understanding the cause of one or more episode. The user may also select one or more cameras to display and/or add or remove one or more cameras from the display for the selected time. As illustrated, the individual camera feeds may also be manipulated, such that a user may play, pause, forward, or rewind one or more of the given data streams. Although illustrated as camera feeds, the user interface is exemplary only and may incorporate any data stream captured by the system, such as sensor information, audio, visual, or other data. Exemplary embodiments may also include combinations of the timeline and lists of epochs as described and shown by FIGS. 18A and 18B.

Exemplary embodiments may include any combination of timelines and video(s) overlays. Exemplary embodiments may include automated camera context switching. Exemplary embodiments may include combination of information displays that may include camera feeds and/or other information/data types, such as from sensors, user inputs, tags, files, or other sources.

FIG. 18C illustrates an exemplary embodiment in which the visual display can be used to compare different lines at different locations. Such comparison can be used to determine relative efficiencies between plants, compare causes of events, etc. As illustrated, a similar timeline presentation is disclosed but includes two lines within the timeline presentation. The two lines may be lines within the same facility or may be lines in different facilities. The different events, identified as episodes, may then be displayed and compared. As illustrated, the cameras feeds associated with the second timeline may also be provided on the screen to directly compare camera feeds from the two timelines associated with one or more given events. The user may also select one or more camera feeds (or other received data stream) in order to review desired locations or information within the one or more locations, facilities, and/or lines. For example, the system may select one or more data sources to display that is related to a given episode as it is encountered on the timeline. The system may permit the user to provide input into the system to identify one or more data sources in which to display. In an exemplary embodiment, the timelines may be tied together such that the associated times between the lines in comparison will play simultaneously. The timelines may be tied together by events, such that a selection of an episode type on one timeline may provide a corresponding similar episode on the other timeline. The time lines may be independent and permit viewing of the respective timelines independently of each other.

Exemplary embodiments may also be used for side by side observation of two or more processes and/or parts of a process. The two or more timelines and/or views may be linked and/or may be fully independent. A user may therefore select different data sources and/or different time segments in which to view portions of the same process and/or different processes. The system may therefore be used to visualize different combinations for comparison and/or observation, such as, for example, viewing the same action or station between different shifts, the same action along different portions of process or performed simultaneously by different resources or at different site locations, the incoming streams to a branch, or simply different portions of interest to the user, and any combination thereof. Once selected, the selected timelines and/or data source visualizations may be linked so that they run together in time (such as taking a single command to start and stop the visual displays) and/or may be separated and independently controlled such that a user may view different portions of the visual displays at the desire and input command of the user.

In an exemplary embodiment, the indication of one or more events, identified as episodes in FIGS. 18A-18C may include additional information according to embodiments described herein. For example, the identified episodes may include a tag or identifier of a source or root cause of the event that is flagged. The identified episode may be color coded or include a text description to identify information about the episode. FIG. 18C illustrates an example in which the source is identified on the episode icon, as well as the icon being visually identified (which could be color, but is provided in distinct patterns for illustration purposes).

As illustrated, the timelines may include a user input for the user to zoom in and/or out of the timeline. Zooming in on the timeline may permit the timeline to expand such that a total illustrated time duration is reduced. Such expansion of the time line may permit more detail into the episodes of the timeline. For example, when a timeline is zoomed in, the root causes may be identified within a given episode. Zooming out on the timeline may permit a larger time duration to be shown within the represented timeline. The icons of the episodes may be reduced, and may include less information of the respective events. FIG. 18D illustrates an exemplary embodiment in which the timeline is zoomed out. If the timeline is expanded to include multiple days or sufficiently large durations of time, the episodes may be consolidated into blocks and a total number of episodes occurring within a given duration that is a subunit of the displayed timeline duration is provided to the user. Other information may be summarized within a block, such as the associated down time or time attributed to the critical events or inefficiency events within that block of time. Information may be provided to a user when the user hovers over a period of time. For example, when a user hovers over a time segment, such as the 4 hour block illustrated in FIG. 18D, the user may receive summary information in a pop up or window that is displayed for that period. The user may see the total number of events for the period, an attributable delay time for that period, root causes or identifiers of critical events within that time, whether the block is identified as normal, better, or worse than a target performance or average performance, the associated tags, etc. or a combination thereof.

In an exemplary embodiment, the user may then select that episode indicator and expand the timeline to encompass the episodes indicated in the given subunit. The zooming feature permits a user to obtain a high level understanding of a performance of a line over different time durations, which easily navigating to different levels of granularity to assess, review, and understand root causes of events and/or improve and/or compare efficiencies of a given process. In an exemplary embodiment, when a timeline is zoomed out, the timeline may identify an icon or a block representing the total time lost for one or more events or episodes within the time duration, and/or the number of events/episodes that contributed to the total time lost. This permits a user to review one or more lines, locations, etc. at a higher level to then focus on the events that have the most impact on the overall performance (either in the number of events and/or in the total time lost or affecting the performance of the line). Exemplary embodiments of the zoom in and out feature may be to provide an expanded or condensed timeline and/or to provide aggregated displays of information. Exemplary embodiments may provide aggregation of statistics about the occurrences (such as tags, episodes, events, root causes, etc.) within a timeline as the timeline is zoomed in and/or out.

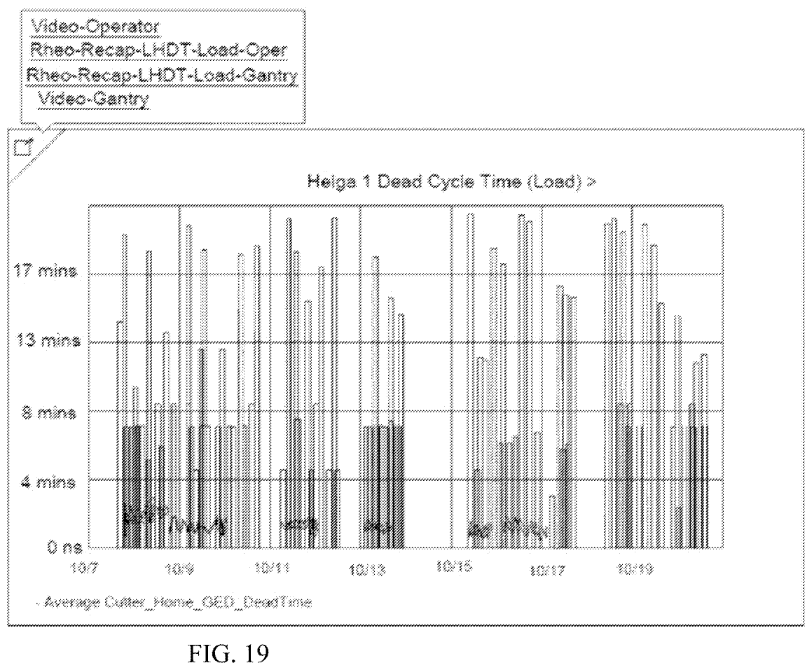

As illustrated in FIG. 19, the system may provide video clips from multiple camera streams (to get the field coverage) corresponding to those specific epochs or other displayed metric.

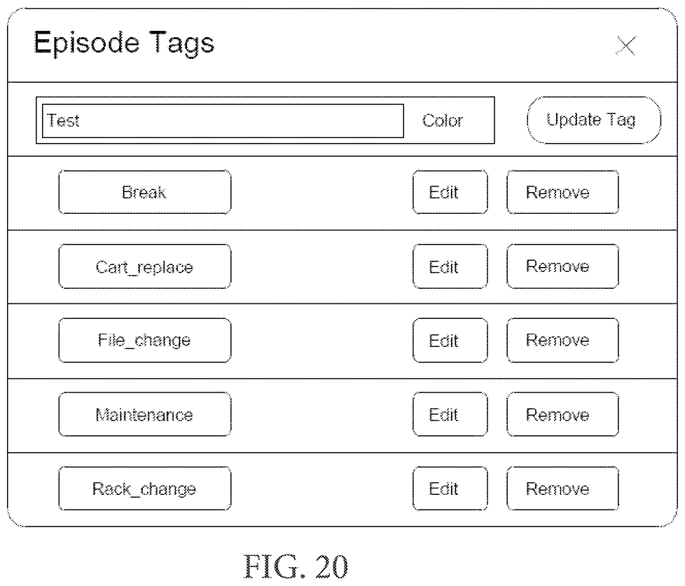

As illustrated in FIG. 20, the system may permit a user to create tags and apply a corresponding tag to specific videos or other metric time. The tags may be used to assist in machine learning to identify metrics, issues, and causes in future iterations. The system may be configured to automatically tag the videos by learning from tags associated by users to videos using the Pre-Processor Blocks, Instantaneous Snap-Shot Processing Blocks, Time-Dependence Processing Blocks etc. The human and machine interaction may be used to complement each other, to improve the accuracy and automation of the tagging system.

According to exemplary embodiments, tags may be assigned at different hierarchies. For example, a tag may be assigned based on an episode, such as to identify a root cause. A tag may be assigned across a time duration, such as an hour or a day, or a duration of use of a resource (such as a personnel shift). Tags may provide specific information about the associated time, such as a root cause of an episode. Tags may provide general or summary information about the associated time, such as whether targets were met during the associated time or not. Exemplary embodiments described herein may use the tags to filter episodes by specific duration range, root causes, machines, resources, etc., or a combination thereof.

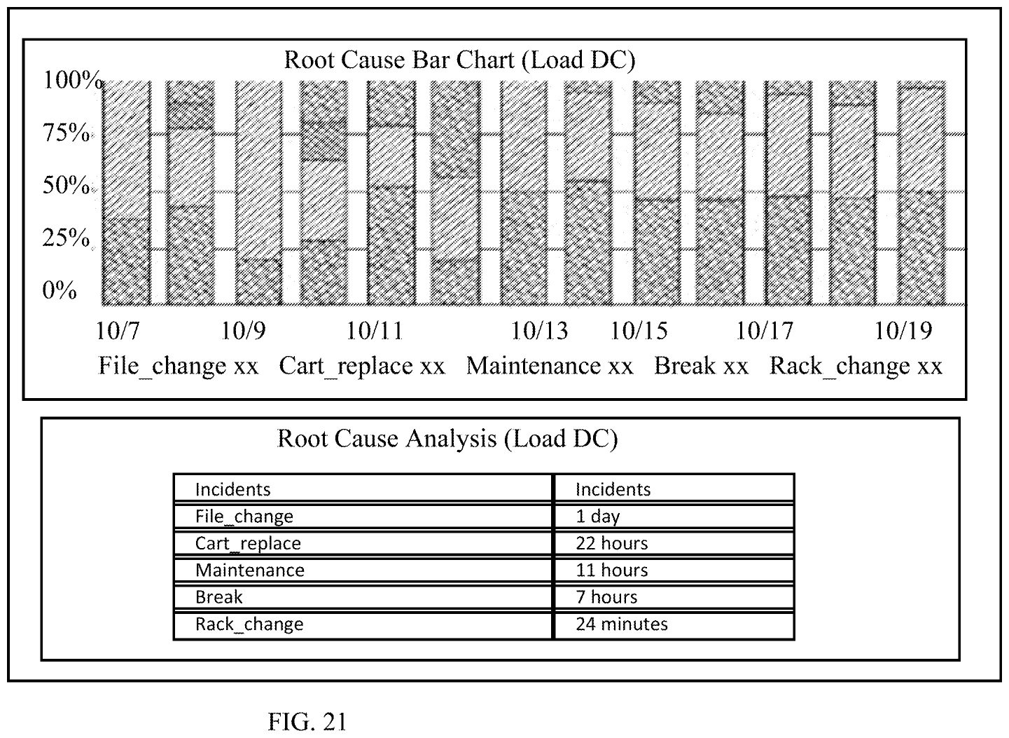

As illustrated in FIG. 21, exemplary embodiments may automatically provide a chart of the root causes using either user entered or automatically generated tags. Exemplary embodiments may provide video playback at variable speed or permit a user to set a speed control to quickly view a video or compiled video clip(s). In an exemplary embodiment, the system may be configured to provide a summary video that stitches all selected, desired, tagged, or other compilation of videos into a single or a few videos that summarizes the events for a longer time (e.g., day, shift) in one video. Compilations may include different feeds from simultaneous sources and/or may include feeds in time durations. Exemplary embodiments may be used to simulate the effects of removing the root causes of an identified inefficiency.

Exemplary embodiments described herein are directed at systems and methods for accelerating improvements in a process. In order to make the accelerated improvements, exemplary embodiments include using cameras and other sensors in order to observe and detect events within the process and identify inefficiencies from those events. As described herein, events may be determined based on an object moving into and/or out of a station, the use of a particular machine, such as when it is on, off, in use, and/or idle, the location of people and/or other resources for use in the process, and a combination thereof. After determining the events, exemplary embodiments of the systems and methods are configured to take the identified events and easily and efficiently display the incidents in a way that a line manager and easily see and identify root causes of inefficiencies. Exemplary embodiments provide efficient association of one or more video streams of the events so that manager can manage causes and/or determine how to best improve the situation causing the root cause of the problem. Because of the use of videos to illustrate a situation associated with an inefficiency, additional information may be portrayed to the viewer, such as the situational emotions at the time of the inefficiency. This may permit a manager to correct or improve the inefficiency while defusing tensions and minimizing defensiveness or accusations by knowing the sensitivities and emotions associated with the event by directly being able to observe the event. The videos may provide more information about a situation that can be obtained visual that may not be captured in other systems. For example, the user observing the video may use their emotional intelligence to see and comprehend visual cues associated with an operator that may not be recognized by the system. For example, an observer of the video may recognize someone has been crying, sneezing, blowing their nose, etc. that may not be recognized by the system. The user may then make conclusions such as the person may not be feeling well, or is upset that may impact the operator's performance and respond accordingly.

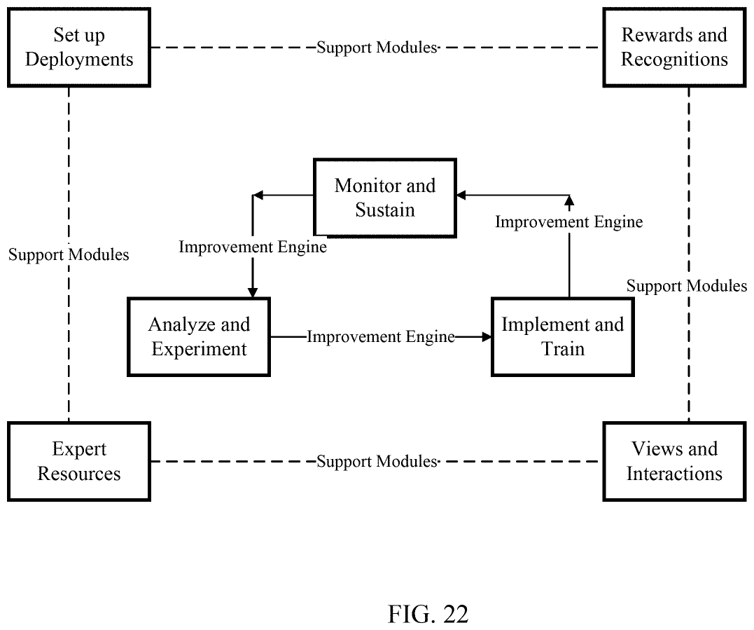

FIG. 22 illustrates an exemplary block diagram that permits the receipt, analysis, and sharing of information within the system to achieve the efficient identity of inefficiency events, while permitting collaboration and system improvements to observed processes. Exemplary embodiments as illustrated may also bring together collaborators and third parties to the process for efficient improvements.

Exemplary embodiments of the present system described herein may include a core implementation engine. The core implementation engine may include an analysis phase, an implementation phase, and a monitoring phase.

The analysis phase may permit analysis and experimentation according to embodiments described herein. For example, the system may receive and analyze the information from one or more sensors in order to identify one or more inefficiency events. The system may also permit a user to create experiments in order to modify the processes and make predictions based on the proposed modifications. In an exemplary embodiment, a user may identify one or more inefficiencies as presented by the system and propose one or more experiments in which to reduce the effects of the inefficiency or eliminate the inefficiency. As described herein, the system may suggest experiments to address a given inefficiency event (or critical event). The suggested experiments may come from prior experiments of a user, from the system analyzing other experiments, template experiments programmed into the system, and/or experiments of other users of the system.

In an exemplary embodiment, a user may create an experiment as described herein. Exemplary embodiments of the system described herein may include a system input configured to receive a problem statement, objective, resources (including identity of operators, skill sets of operators, etc.), descriptions, observations, etc. The system input may be a user input to permit a user to make selections, enter text, etc. as described herein. The system input may be through the one or more sensors described herein. The system input may be through buttons, screens, etc. In an exemplary embodiment, may include determining a baseline time, process flow, etc. based on the system inputs. Exemplary embodiments described herein, may use the system inputs to generate process implementation plans as described herein. Exemplary embodiments described herein, may use the system inputs to generate similar experiments, additional or alternative experiments, process improvements, suggested contacts, external resources, or a combination thereof or additional information as described herein.

The implementation phase may use the information gained by the analysis and experimentation phase in order to make actual physical changes in the process that correspond to virtual changes proposed in the experiment. For example, one or more changes may be identified through the analysis and experimentation phase that provides an improvement of the inefficiency for a price point desirable by the process owner. The owner may then implement the changes corresponding to the one or more experiments that resulted in the desired improvement for the associated costs. Exemplary changes may include purchasing additional equipment, reallocated resources, moving resources, repositioning the layout. Because the changes are known as compared to the prior implementation, training may be implemented to train new users on equipment, train on orders or priorities, train on relocation of equipment, etc. The training may be targeted for the specific implementation.

The monitoring phase may include observing the changes over time, such as by using exemplary embodiments of the sensors and monitoring systems described herein to capture images and information from one or more sensors and displaying the information to a user.

Exemplary embodiments of the present system described herein may include a support implementation engine that works in combination with the core implementation engine. The support implementation engine may include expert resources, views, rewards, and setup.

In an exemplary embodiment, the core implementation engine may be supported by expert resources. The expert resources may be provided through one or more interfaces into the system. The expert resources may include produces and/or services for purchase, like a marketplace. Once an inefficiency is identified, a user of the system may use the platform to order the resources necessary to improve or correct the inefficiency. For example, the expert resources may include materials for purchase, such as, for example, carts, machines, etc. The system may also permit the purchase or order of supporting services, such as, for example, installers, programmers, etc. Exemplary embodiments may also permit collaboration of one process with another process within a plant or between processes from multiple plants, whether owned by the same plant owner or not. The expert resources may therefore come internally from within the same organization and/or plant and/or may be external to the organization and/or plant. Different operators may therefore collaborate to provide advise and communication to each other as they work through proposing and implementing solutions within their plants and/or processes. Exemplary embodiments of the system for supporting expert resources may therefore include communication interfaces that may permit for calling, video conferences, texting, chatting, or other forms of communication, whether between individuals on the system or among groups, such as by posting to a common user interface location.

In an exemplary embodiment, the core implementation engine may be supported by rewards systems. In an exemplary embodiment, the system may be configured to recognize and/or identify actions and provide rewards in response thereto. For example, the system may recognize the entry of experiments that improve a process in terms of time, throughput, use of resources, or a combination thereof, and when execute and an improvement made, the system may assign rewards to the users that implement or participate in the improvements. The system may also recognize actions of a user, such as being at their station, hitting a desired through put of products, maintaining a machine in a specific state, such as in use, for a desired percentage of time, or other target objects that can be monitored by the system. If desired targets or actions are performed, the user may earn points or achievements. The system may also or alternatively provide a score board or other ranking system. The system may display resources, such as personnel on a process line, and rank a performance based on one or more parameters as described herein. The system may be configured to earn points for personnel that are highly ranked.

In an exemplary embodiment, the core implementation engine may be supported by different interactions systems. For example, the system may integrate with third party or conventional conferencing systems. The conferencing systems may permit users to interact and share content through video and/or audio interface. Exemplary embodiments may include control systems that permit a user to command or provide inputs to the system through gestures and/or vocal commands. The system may use gesture or vocal commands as inputs for when a resource is engaged, or running equipment, for determining the presence of an inefficiency event, for tagging, for changing or providing views through one or more displays, for providing indicators for reallocating resources, etc. Exemplary embodiments may use gestures or other signals that can be received through the camera and/or one or more sensors and analyzed for its command. Gestures may be used as input commands, especially in environments that may have noise that could interfere with the detection and recognition of audio commands.

In an exemplary embodiment, the core implementation engine may be supported by set up deployments. For example, as described herein, the system may be used with various combinations of sensors, inputs, cameras, etc. The system may be set up for the various inputs to communicate with the system so that the system can then analyze the information and provide the desired results in a visual form to the user.

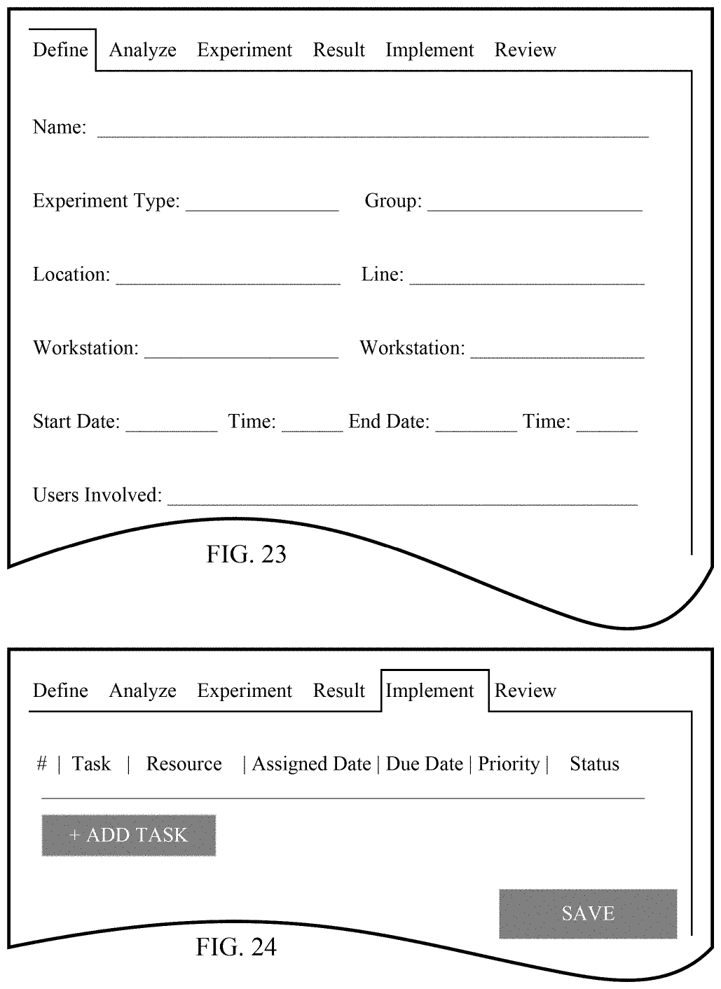

FIG. 23 illustrates an exemplary interface for an experiment module according to embodiments described herein. The system may comprise templates for entering information for creating an experiment. After the analysis module received information about a process, and analyze the processes for determining inefficiency events, the system may permit a user to try experimentation. The template may automatically populate or generate fields based on the previous analysis of the process. The user may enter a name of the experiment, identify groups and/or locations of the processes in order implement experiments proposed by the user and/or system. The system can identify start and end dates and/or times to try the experiment. In an exemplary embodiment the system may automatically update start and stop times, and/or a user may manually enter information. For example, the system may receive inputs from a user for start times of a baseline statistic and experiment statistic.

FIG. 24 illustrates an exemplary interface for assigning tasks within an experiment. The task may assign a user or other resource and may identify the change from the previous implementation of the process. The tasks may also be assigned to prepare for the implementation of the experiment, such as in redesigning or moving process layouts, order materials or additional resources, etc.

The system may also provide user interfaces for permitting a user to provide reviews, scoring, comments, etc. associated with a given experiment.

The system may also provide analysis after the experiment is run. The analysis may compare metrics from before the experiment to during the experiment so that changing in inefficiency events can be determined. The user interface may include features similar to those described herein in which inefficiency events are identified and associated with sensor data streams, including cameras and video in order to observe changes in the experiment process. The system may also provide process metrics to compare the experimental process with a prior process. The process metrics may, for example, provide information on a total inefficiency time, total through put of products, time efficiencies, resources used, etc. as described herein. The process metrics may include information from before the experiment to during the experiment so that the experiment success can be directly determined through comparison of the process metrics.

Exemplary embodiments described herein may enhance efficiency and permit improvements across lines, processes, companies, etc. For example, exemplary embodiments of the system may identify inefficiency events and provide a root cause of the inefficiency event. Experiments may then be proposed and/or created by the system and/or users. The effects of the experiments can be monitored and the results of the experiment over the original inefficiency event can be quantified. For example, the increase of throughput, utilization of resources, cost of resources, etc. can be determined prior to the experiment and during the experiment. The system may then include a database of root causes and exemplary solutions for the root causes to increase performance. The return on investment or improvement parameters may be estimated for different solutions based on the experiments run. The system may therefore provide suggestions of improvements based on experiments run, may provide contact information or permit communication through the networking or expert portals in order for personnel to connect and discuss or learn from inefficiency events that had improvements on other lines, facilities, locations, or companies.

Exemplary embodiments may therefore provide one or a combination of different features of finding improvements to inefficiency events. Exemplary embodiments may permit contact or introduction to other users having similar inefficiency events, similar process lines, etc. Exemplary embodiments may provide suggestions for improvement for an inefficiency event. Exemplary embodiments may provide a list and associate improvement parameter from other experiments or solutions implemented for a similar inefficiency event.

Exemplary embodiments described herein may analyze a process line and segregate the line into process sections. The process sections may be associated with dependency events, such as resources used within the section. The dependency events may be any contributing factor to the time associated with the process section. The system may then analyze the process sections and associated dependencies in order to analyze slowdowns associate therewith and provide suggested improvements thereto. Exemplary embodiments described herein may include improvement reports that provides information on root causes. The improvement report may separate the process section into isolated focal areas, such as dependencies, that may be sources of inefficiencies in the line. The system may therefore be used to identify specific workstations, specific dependencies, specific slowdowns, specific root causes, etc. The system may thereafter provide suggested improvements thereto.

In an exemplary embodiment, the system may identify similar inefficiency events through machine learning, tags, or other indicator. For example, the classification of an inefficiency event may be determined based on non-use of resources (down time or non-operation of a machine or person), the root cause such as waiting for a resource, etc. The system may identify the type of resource that is causing the inefficiency event, such as the resource being under utilized or over utilized. For example, a cutting machine may provide a back up of parts when waiting for the machine's use, other resources may be transport resources, such as carts, etc. Other exemplary root causes may be in the placement of resources, components, etc. relative to the stations that use the resources or components, and/or in the movement of resources that may be determined from the heat maps as described herein.

Exemplary embodiments may therefore reduce the trial time for improvement inefficiency events. The system may permit users to learn or advance based on the experiments of other users of the system and not simply recreate solutions from scratch for each line, process, facility, location, or company that encounters a given inefficiency event.

Exemplary embodiments may also permit sharing of experiments. Users may observe experiments conducted or created by other users to determine how improvements were experienced based on specific inefficiency events. Users may therefore observe actions conducted by other users to determine whether improvements may be had at their own facilities or processes. Exemplary embodiments may include descriptions of experiments, goals of experiments, summaries of experiments, thoughts and lessons learned from an experiment, inefficiency events, root causes assigned to an inefficiency event, tags associated with an inefficiency event, tags associated with an experiment, tags associated with a result of the experiment, etc. Users may then search on the descriptions and associated information of an experiment to find similar experiments for observation.

Exemplary embodiments described herein may permit a user to identify a previous experiment, whether performed by the user and/or found in the system through interaction with the system and/or other users. The user may then copy the experiment to prepopulate details of the experiment in the event the user wants to use the previous experiment to create a new experiment. The user can then change, add, or remove details or information from the copied experiment in order to expedite information input into the system to create a new experiment.

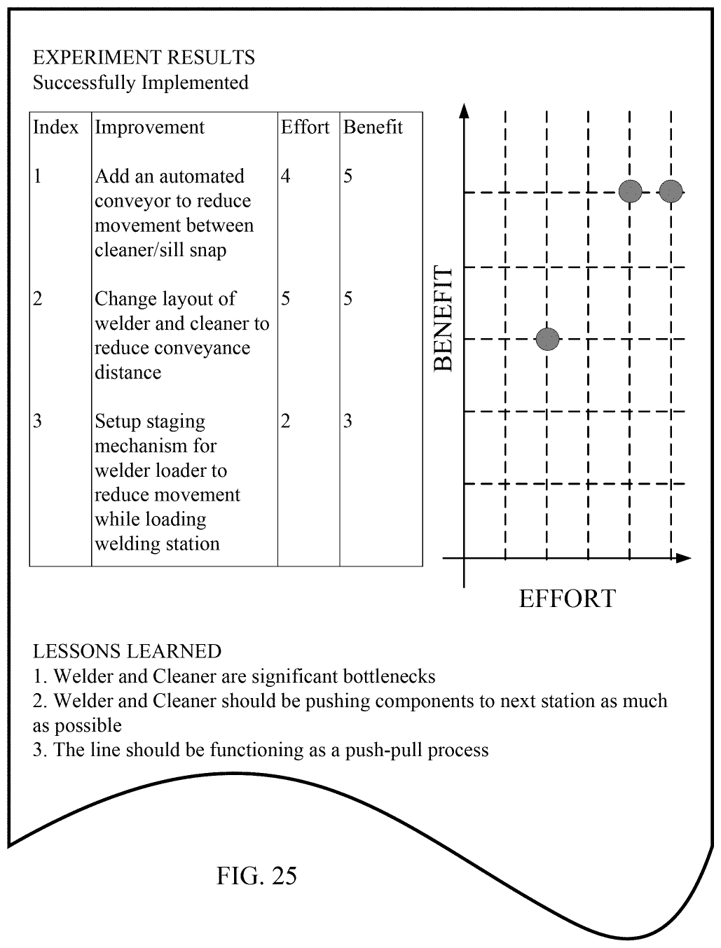

FIG. 25 illustrates an exemplary embodiment of a user interface for illustrating results of an experiment. Users and/or the system may identify changes made for the experiment. As illustrated, changes may include moving layouts, adding staging stations, adding resources (such as machinery or personnel), removing resources, reallocating resources, etc. The system and/or users may associate an effort associated with the change. The effort may include the difficulty of performing the action, a cost of achieving the action, an amount of time for achieving the action, etc. The system may use the tasks input from the user to assist in determining changes made and/or determining an effort value for an improvement. Exemplary embodiments may also include the benefits achieved by the change. The system may determine the benefits based on improvements to the inefficiency event and/or the contribution of the change to improving other process metrics, such as the improvement in throughput, utilization of resources, etc.

Exemplary embodiments may use text analytics in order to associate experiments together and/or in searching or finding features from one or more experiments. The system may therefore create a database of experiments, improvements, processes, etc. That permits users to search therein. Exemplary embodiments may also permit searching over data streams, such as videos.

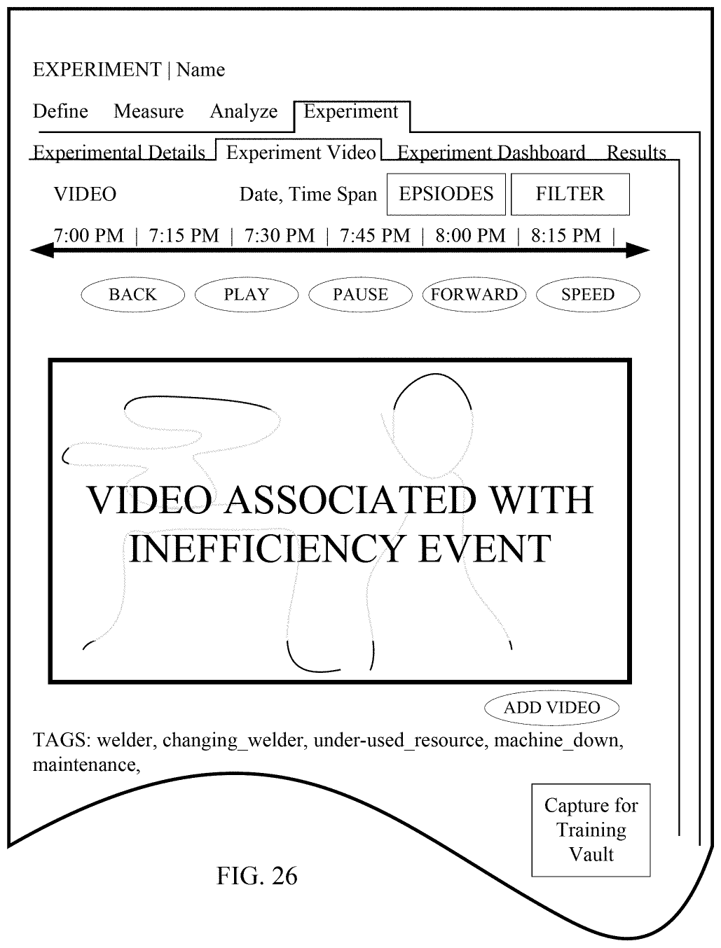

FIG. 26 illustrates an exemplary user interface that permits a user to observe data feeds associated with an experiment. The experiments may use any displays as described herein for the system and methods for observing and analyzing a process. Exemplary embodiments may identify the experiment, provide a timeline of videos, identify inefficiency events that are identified, the associated video in line with the associated timeline, and/or tags associated with the experiment, the portion of the timeline, video, etc. Exemplary embodiments may also include an indicator of where prior inefficiency events occurred as compared to the process run prior to the experiment so that improvements or changes may be seen.

Exemplary embodiment may also permit users to identify sections of sensor feeds, including video streams, associated tags, inefficiency events, experiments, and a combination thereof in order to create training segments. For example, a comparison between a prior process and an experimental process can be identified and aligned so that the inefficiency of an original process and the improvement to the process through one or more changes made in the experiment. The associated video fees can be aligned and synchronized so that the improvement or effect of the change can be easily observed. The one or more feeds may be saved to a vault in separate video forms and/or as synchronized to permit easy training examples for use at later times. As illustrated in FIG. 26, a training vault button or location may be identified on the user interface. The user may identify a second of feed and transfer it to the training vault. The captured feeds may be associated with one or more tags, or other identifier in order to retrieval, searching, and/or use at a later time.

Exemplary embodiments may include a training module. The training module may use one or more data streams as captured or saved during the use of the system, such as described herein. The training module may use the captured data videos in order to permit a user to observe an event. Exemplary embodiments may include automated and manual options for generating information, associating information to video segments, determining video segments, etc. Exemplary embodiments may therefore permit manual and/or automated selection of video segments for capturing information and/or for use in training. The training module may also provide one or more questions to a user of the training module to receive feedback on the video observed by the user. The user may then provide answers, such as in a test format in order to assess the knowledge gained by the user through observation of the feeds. The training module may also permit voice over recording for a trainer to explain events within the video and/or provide text explanations of what is occurring in the video for training purposes. Exemplary embodiments of the training module may also permit an administrator or user of the system to assign training activities to one or more other users. The assignments may be for identified segments or training clips, identified question and answer segments or tests, etc. The assignments may identify due dates in which training must be completed. The system may track when a user has performed an assignment and/or the results of their performance on the assignment. The system may automatically update a skills matrix associated with the operators as described herein.

In an exemplary embodiment, the training module may be a video created specifically to operate a machine, perform maintenance on the machine, clean the machine, etc. The training module may permit a user to observe the training video. The system may then use the one or more sensors to detect an operating performing the task from the training video (such as operating, maintaining, and/or cleaning). The system may retain a recording of sensor feeds for quality assurance, maintenance tracking, further training, personnel assessment, or other administrative purpose. For example, a system may have to be cleaned at predetermined interface of time or after certain amounts of use. The system may track the associated time and/or use. The system may then require a user to observe a training video corresponding to the cleaning. The system may then ask the user to conduct the cleaning while the system records the actions of the user. The system may identify actions performed by the user that correspond to the required steps of the training. Exemplary embodiments may also or alternatively analyze the performance of an operator to make determinations of their performance. For example, the data streams may be analyzed to determine a time of completion for actions to generate cycle times and/or throughput of an operator. The system may use this information to assess operators, and/or prioritized operators when making line assessments and recommendations based on available resources as described herein. The system may save the video for observation by a supervisor or site manager at a later time. The system may track the maintenance and/or cleaning of machines in order to determine when the next maintenance and/or cleaning should occur. The system may retain the data streams of videos or other sensors confirming the maintenance and/or cleaning occurred for quality assurance and/or general record keeping. Exemplary embodiments of the system may compare actions of a user against a recorded action, such as the training video or prior captured action to make comparisons of the user against the prior action. The system may, for example, be configured to display in side by side fashion the prior video and the current video so that a user may rank, score, and/or provide comments to the user and/or record notes relevant to the event in the system. The system may also or alternatively provide automated comparison of the data streams in order to determining a conformity, determine a threshold requirement is met, to provide scoring, to provide information relevant to the event, etc. Exemplary embodiments of the systems and methods provided herein may compare a reference video against an operator video to determine a conformity therewith and/or provide a rating relative to the conformity thereof.

In an exemplary embodiment, the system may monitor actions of users and determine if actions are missing from their performance. For example, if a machine should be cleaned at a specific interface or at an end of a shift or at some duration, but the system does not detect a cleaning action of the machine, the system may provide a notice to the user and provide associated training materials in order for the user to operate the machine correctly. The system may also monitor machines, workstations, tasks, etc. In a similar fashion, if the metrics associated with a user are out of a normal operating range, such as below a threshold amount (they are taking longer to perform a task), then a training video may be provided to the user to assist their use of the machine and improve their metrics. The system may provide instances when the user performed better or from others that are performing better to provide training and improvement for the user. Exemplary embodiments may include monitoring of workstations, machines, tasks, etc. at various levels of granularity as desired by the system and/or system administrator.

Exemplary embodiments of the systems and methods described herein may provide automated updating of the resource skills matrix through recognition of employees. For example, the system may recognize an operator at a workstation and/or know the assignment of an operator to a workstation. The system may thereafter track the operation time at the workstation and associate the time to the operator within a skills matrix. The system may thereafter track a total use time for an operator and/or most recent operation time for a given skill set and/or machinery. The system may also track the user's efficiency at the workstation and/or the comparison of the operator to a programed process step. The system may use these metrics in order to rank an operator, suggest training, log associated time for the operator, value the time of the operator at a given workstation, or a combination thereof. In an exemplary embodiment, for example, if the operator is inefficient at an operation and/or is performing incorrectly, the system may not track or associate that time to the operator, but instead suspend allotment of such time until the operator improves or performs training for the given task. The system may thereafter use this information to suggest operators for process steps, assignment or allocation of resources, process line optimization, training suggestions and/or requirements, further training for expanding operator skills, etc.

In an exemplary embodiment, the training module may provide training opportunities or recommend training for users based on operator metrics, recency of exposure to use of the machine, skill levels, machine requirements, or a combination thereof.

Exemplary embodiments of the system and methods described herein may permit automated and/or semi-automated and/or manual training material generation for episodes of inefficiency and/or good working epochs. For example, good working epochs may be captured for training purposes. Periods of inefficiencies may trigger the system to display an option to the user to take additional training and/or display a preferred operation of the workstation for the user to immolate.

Exemplary embodiments may also permit training in various languages and/or styles (such as audio instruction, visual demonstration, images, etc.) in order to accommodate the characteristics of the personnel, including their language of choice and/or learning style, and/or for the limitations of the workstation. Exemplary embodiments of the system described herein may be configured to automatically translate training materials in various languages. For example, exemplary embodiments may include text to text machine translations, speech recognition to text translations, text translations using speech interpreter so that different combinations of test to test, speech to text, and/or text to speech may be used to provide information to an operator.

Exemplary embodiments of the system and methods described herein may provide automated recommend training requirements based on metrics, recency of exposure to the station, and/or other operator/resource characteristics. In an exemplary embodiment, the system may recognize the advancement of training from a set of skills already achieved by an operator to suggest and/or require additional training that relates to other workstation sin the process line to expand the skill sets of an operator to be more versatile in process line planning between shifts.

Exemplary embodiments of the systems and methods described herein may also use and/or embed training resources available from other systems. For example, the system may provide links and/or embed videos from other resources and/or platforms and/or videos created by or for the machine manufacturer or process line. Exemplary embodiments may use video and/or instructions received during the process capture and/or analysis steps described herein.

The system may also be used for quality assurance by capturing videos or segments of a process as identified by a user. In a similar fashion, segments of sensor feeds, such as videos, may be identified by a user and stored in a database for quality assurance, line process, personnel review, or other administrative needs.

The system may receive instructions on which sensor feeds or outputs of the system the system should save for training or other administrative need. For example, a user may use a “record” button to identify a segment, the user may enter in start and stop times and associated feed in which to store, the system may suggest segments such as associated with inefficiency events, the user may select portions of a timeline, such as through selection of buttons or drag and drop features through a device input, etc. The system may also be configured to play back portions of video at various speeds. The system may permit a user to select a playback speed and/or may automatically select a playback speed depending on the purpose of observing the video and/or based on actions within the video for faster observation of lower priority activity and slower observation of higher priority activity.

Exemplary embodiments of the system may also permit training interfaces at one or more resources within the process. For example, equipment may comprise a screen and/or x′ kiosk that permits a user to select training sessions associated with that equipment. The user may then select a training session in order to learn about the equipment in order to use the equipment.

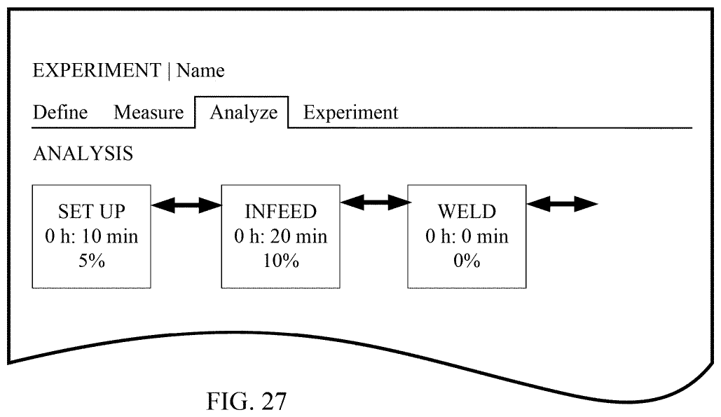

Exemplary embodiments of the system may permit analyze the experiments and provide allotted improvements based on different actions for the segment. For example, FIG. 27 illustrates an exemplary user interface analyzing a given experiment. After the experiment is conduct, different actions for the segment being analyzed or altered may be broken into different steps. The system may identify the different steps in the process during the experiment and may compare metrics to previous performance of the process. The system may then identify improvements made or contributed by the different steps of a process. As illustrated, a welding process is provided in which the welder must set up the components to weld, provide the correct materials for the machine, and then perform the welding. An experiment may include repositioning the staging area and/or components and/or create different component station configurations so that the set up and infeed time are reduced. The system may analyze the improvements down to the different events performed in the given segment.

Exemplary embodiments of the system may permit users to add additional feeds or information into the system. For example, tablets and/or mobile electronic devices may be provided in the process line. User may use the mobile electronic device to enter tags, log in work times, take videos, enter questions, provide line feedback, etc. into the system. In an exemplary embodiment, the mobile electronic device may be used to indicate cycle times for a given workstation. A user may therefore use the mobile electronic device to scan a component part as it enters or leaves the workstation. A user may also or alternatively use the mobile electronic device to enter a user input, such as push a start and/or start button to indicate the start and/or end of a cycle of that workstation. The system may then store the entered information in the timeline associated with the process and/or other sensor feeds corresponding to the same areas of the process. Therefore, exemplary embodiments may permit the system to identify where in the process line the mobile electronic device is in order to arrange its inputs relative to the rest of the process and associate the entered information to specific process locations, resources, etc.

Exemplary embodiments described herein may use the system analysis and features described herein to provide personnel and/or managers process line reviews at desired intervals. For example, personnel on a process line may receive performance summaries at the end of their shift and/or at a beginning of a shift for their performance from the last shift or a prior shift. The personnel may receive other metrics such as their best and/or worst and/or average performance metrics. The personnel may receive information of their performance compared to others performing similar functions in the process or performing the same function on different shifts. Exemplary embodiments of the system may use push notifications to send information to users.

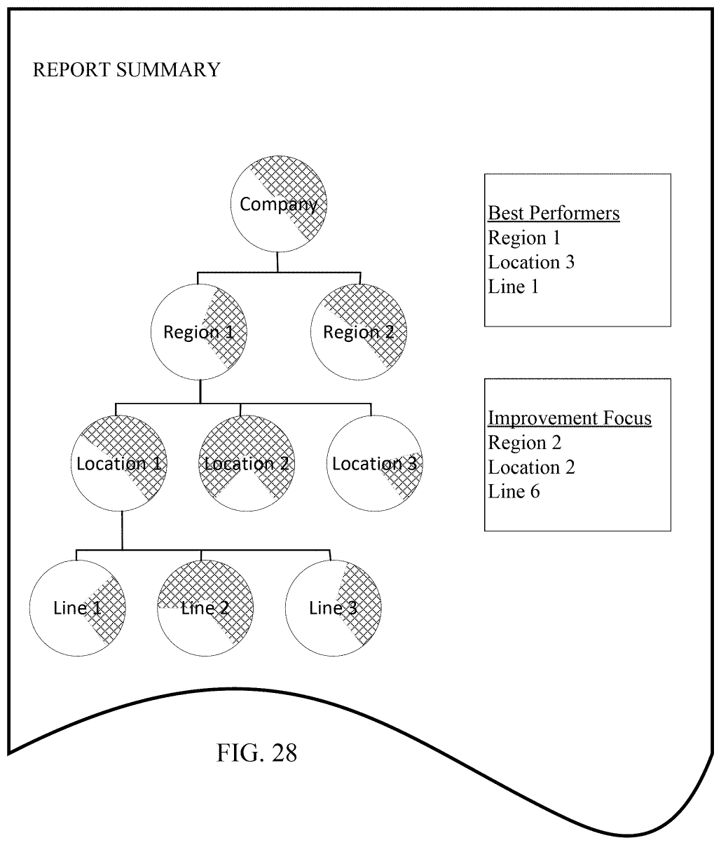

Exemplary embodiments of the systems and methods described herein may permit roll up and/or drill down information user interfaces. FIG. 28 illustrates an exemplary user interface for a company. The system may permit metrics associated with different segmentations of the company. For example, a total efficiency of a company may be identified having multiple locations, processes, etc. The system may then permit a user to select the company and/or brand if a company has multiple brands. The system may divide multiple locations into regions, so that a user may select a region and see the multiple locations associated with the region. Then for a specific location, the user interface may display multiple processes or lines within the location.

The system may also provide high level summary information such as those divisions that are best and worst performers.

For each of the displayed divisions, the system may provide an efficiency visual so that a user can visually compare the performance of one group to another. As illustrated, the cross hatch region may indicate times of inefficiency events as compared to the unfilled region of properly working times for the grouping.

The user may select any grouping or icon displayed within the drill down summary in order to provide additional metrics associated with the grouping. For example, the user may select a region, location, or process. The user may then see the metrics associated with the grouping including the inefficiency information, utilization metrics of resources, average throughput of products, etc.

In an exemplary embodiment, the user may right click on an icon to obtain different user displays that the user may select for the given grouping. For example, the user may see the dashboard of metrics associated with the grouping, a list of sensor feeds, such as videos, or shift, line, or grouping information associated with the selection.

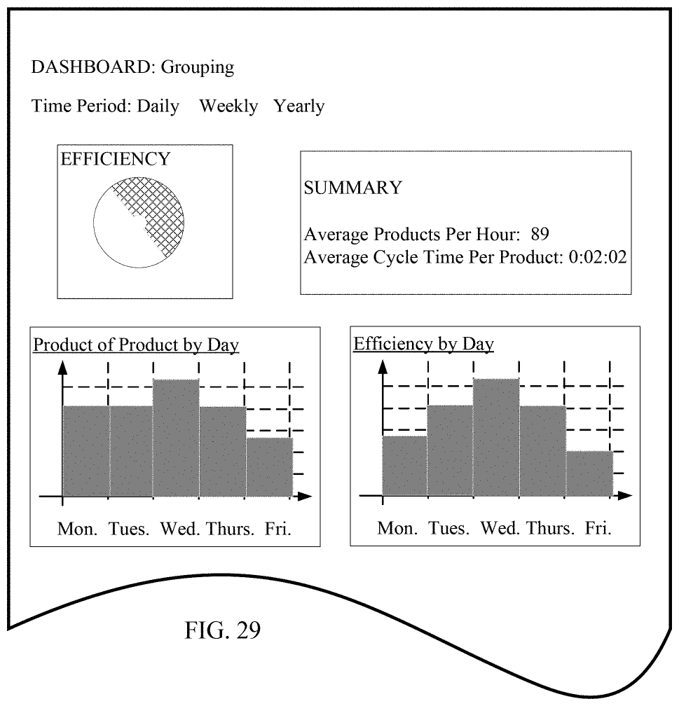

FIG. 29 illustrates an exemplary user interface of a dashboard that may be displayed to a user that selects a grouping from the user interface of FIG. 28. The dashboard may provide additional information for the selected grouping, such as one or more metrics for the given grouping. Exemplary metrics may include number of products made within a period of time, the average amount of time to make one product (production cycle time), a listing of inefficiency events, a total determination of efficiency for the grouping. The summary information may be provided for select periods of time, such as daily, weekly, monthly, yearly, or in segments of time over a period of time, such as a graphical representation of a metric over different periods of time.

Exemplary embodiments of the system may be used to provide information to a user and/or personnel within a location. Exemplary embodiments described herein provide information to a user in various formats and user interface presentations. The system may provide metrics on process efficiencies, root causes of inefficiencies, implications or metrics associated with inefficiencies, etc. Exemplary embodiments may include a user interface that provides an input from a user, such as a selection of a button, in order to capture the displayed information and to store a copy of the captured information for use in other programs, interfaces, etc. For example, the system may include a capture icon on one or more of the user interface displays. When the user selects the capture button, the user may capture all or part of the information displayed on the user interface. The system may then save the captured information in a desired file format and save the captured information in the desired file format in a desired memory location on the users device and/or system. For example, the user may capture a page of metrics, and the system may save an image file associated with the user interface of the page of metrics and save the file to the user's desktop used to access the system.

Exemplary embodiments described herein may be used to identify critical points on a process line. The critical points may be significant slow downs along a process and/or back ups at a branch point or sequencing of constraints. A process line may be segmented based on the critical points in the process. Exemplary embodiments may be used to improve critical points. Critical points are preferably corrected from the most downstream end toward the upstream end, but the processes described herein are not so limited. A section may be optimized by reducing delays along the section and ensuring all materials and resources are available for the performance actions along the section. Exemplary embodiments described herein permit isolated experiments to be run along just a section to create improvements within a section of a process.

Exemplary embodiments of the system described herein may provide rapid improvement scenarios and provide corresponding rapid impact analysis. Conventionally, when the efficiency of a process is being assessed, a number of people are involved and the process is reviewed for a duration, the number of people identify potential causes, the process is redesigned to address the identified causes, and the process is re-evaluated with the new redesign, which can take weeks. Exemplary embodiments of the system described herein may accomplish similar results in a much shorter period, such as in a matter of hours. Exemplary embodiments may be used to monitor a process over a period of time. The system may be configured to identify information about the process, such as an indication of a percentage of its efficiency (such as the percentage of time that the process is operating within target parameters), an average cycle time (such as for making a part or using a specific piece of equipment), an average dead time (such as for a specific piece of equipment), etc. The system may be used, such as through the use of the user interfaces, the identification of events, the identification of root causes of events, and combinations thereof to identify inefficiencies quickly and identify root causes of inefficiencies in the system. Changes may be implemented and new information may be obtained about the newly implemented process. For example, timelines from before and after the changed process may be visualized and directly compared. After changing parameters, the system may provide updated information about the process. The updated information about the process may be along the same parameters as the original information about the process and/or may be a comparison between the updated information and the original information.

The system may therefore provide a specific quantifiable analysis of improvements of the process by making changes within the process. For example, when a change is implemented, the system may be able to determine an improvement in downtime of a machine, and/or an improvement of through put, etc. and therefore provide an increase in efficiency or overall output of a process. The increase may be equated to specific output of the process and associated value to the change. The system may therefore be able to provide insight into the gains of specific process decision to directly compare and analyse whether any costs associated with a proposed change is ultimately worth the gains achieved by the proposed change. The duration for making such assessments can be reduced substantially as inefficiencies can be identified in a matter of minutes or hours, proposed changes provided thereafter, and observation of newly implemented processes within hours or days to determine the respective effects on the process.

Exemplary embodiments include systems and methods for rapidly assessing a process and/or providing impact analysis on proposed changes to the process based on the assessment of the process. The system and methods may include one or more cameras, analyzing the received data from the one or more cameras, analyzing the received data to identify inefficiency events within a process, and visualizing the identified inefficiency events. The system and method may include associating one or more performance metrics to the process. The method may include users of the system and/or the system identifying potential solutions to identified inefficiency events, and implementing a modified process based on the identified inefficiency events and/or the potential solutions to the identified inefficiency events. The system and method may include using the one or more cameras to analyze received data of the modified process and determining updated the one or more performance metrics to the modified process. The system and method may be used to determine whether to implement the one or more changes made between the modified process and the original process based on a comparison of the one or more performance metrics from the original process to the updated one or more performance metrics from the modified process.

The system and methods may include one or more cameras, analyzing the received data from the one or more cameras, analyzing the received data to identify inefficiency events within a process, and visualizing the identified inefficiency events.

Exemplary embodiments include system and methods for visualizing a process. The method may include receiving data from one or more data sources, including one or more cameras; analyzing the received data; and visualizing the analyzed data. The system may include one or more cameras configured to be positioned about an area in which a process occurs. The system may also include a communications system for the cameras to communicate to a hub, computer, network, each other, and/or a combination thereof. The system may include a processor for analyzing data received from the one or more cameras. The system may include a display or other visualization or notification device, such as a light, speaker, etc.

In an exemplary embodiment, the system may method may be configured to provide an integrated system of cameras for large area monitoring. For example, the cameras may be distributed to obtain a wide area perspective of one or more actions, activities, events, supplies, products, services, etc. within the process. In an exemplary embodiment, the received data may be preconditioned to improve a signal to noise ration.

In an exemplary embodiment, the analyzing of the data within the system or method may include algorithms for improving the efficiency of the data processing. For example, the data from multiple signals (whether form the one or more cameras or from one or more other sensors, and any combination thereof) may be combined into a single snap shot for processing within a single processing frame. For example, at least two images from the one or more cameras may be aggregated into a single processing frame. The aggregation of signals into a single processing frame may reduce the bandwidth of data processed and/or transmitted within the system.

The system and method may include different combinations of aggregated processing information. For example, a first data source creates a first data stream of sequential images and a second data source creates a second data stream of sequential images and the single processing frame comprises a first image from the first data stream and a second image from the second data stream, wherein the first image from the first data stream and the second image from the second data stream correspond to a simultaneous time. As another example, the received data may be aggregated to generate a first single processing frame including at least two images from the one or more cameras and a second single processing frame includes at least two other images from the one or more cameras, and the second single processing frame includes at least two other images at a later time than the at least two images from the first single processing frame.

In an exemplary embodiment, the analyzing of the data within the system or method may include algorithms for improving the efficiency of the data processing. For example, the incoming data may be used to analyze or predict attributes of the data. Within a single processing frame, one portion of the single processing frame may be used to predict information about another portion of the single processing frame. In an exemplary embodiment, the system and method includes determining an area of interest from a first single processing frame to predict an area of interest in a second single processing frame. Within sequential single processing frames, one portion of a first processing frame may be used to predict information about a second single processing frame. Please include one portion of a first processing frame may be used to predict information about the same frame.

The system and method may use any combination of predictions to assist in analyzing the data. For example, the predicted information may be a presence or absence of an object. If an object, such as a worker, is identified in one portion of an image frame at a given time, then the system may first analyze a portion of the frame corresponding to the same location of a subsequent image from a later point in time to determine whether the worker is still at the intended location. If the worker if found, then the system reduces the analyses of the remaining frame as it has already found its intended object of observation. Conversely, if the object, i.e. the worker, is missing from the same location of the subsequent image from the later point in time, then the system may thereafter further analyze the frame to detect a new location of the worker. In even later subsequent frames, the system and methods may use a combination of previous positioned to predict a new position in the later subsequent frame based on prior movement, direction, duration, etc. As another example, the system may track a duration of an action within the process, the system may also be able to detect a start of the action, and therefore use the duration to predict an end of the action. The system and method may use the start and end times of the action to also predict a location of resources corresponding to the start and end of the action.

In an exemplary embodiment, the analyzing of the data within the system or method may include algorithms for improving the efficiency of the data processing. For example, the system may be configured to determine a present state of the process and predict a subsequent state and/or adjust an analysis of the data based on the present state, past state, predicted state, and combinations thereof. For example, a process may have many states, including whether a resources is in position, in use, out of use, out of commission, in a transition, and combinations thereof. Other states may include whether a set of resources (such as inventory) is sufficiently supplied, low, or depleted. The state may be used to analyze the given data. For example, if a given machine is in an in use state, and it runs autonomously for a duration, the system and method may be configured to reduce a fidelity or monitoring of that resource during the automated in use duration. The system and method may monitor for an exception case only, such as an indicator to show the machine is not working (e.g. monitoring for whether the machine is running, within temperature range, etc.), but does not require the more detailed analysis to detect other attributes. For safety protocol monitoring, the system may only detect the incoming information to determine whether there is personnel present within a predefined area while the machine is running. The system may therefore reduce the fidelity (either in time or image resolution) based on a given state. The system may also use the state to predict the next actions, such as when the machine will transition and increased monitoring is desired.

In an exemplary embodiment, the one or more data sources includes at least one data stream of sequential images and the analyzing the received data comprises defining a state based on an image of the sequential images. The state based determination may include determining a location of an object within a region of the image. Other state based determinations may include, for example, a condition of a resources, such as a machine, part, component, inventory, etc. The condition may include whether a resource is in use, in transition, broken, out of use, etc. The analysis of the data may also include using the state to predict an area of interest in a second image in the sequence of images, and the second image occurs later in time than the image. The prediction may be for example that a resource (such as a part or personnel) should be in a desired location after the completion of an action determined by the state. The analysis may further include determining a conformity of persistence of the state from the image to a second image form the one or more data sources. In this case, for example, the system and method may observe a desired resource at a first location and predict the desired resource's at the same location in a subsequent time. The system may determine whether the desired resource actually conforms to the state (i.e. stays in the same location). Other conformity of persistence of the state may include whether a resource stays in use, stays out of use, stays in a transition, is moving, is stationary, is in a desired location, is sufficiently supplied (such as for inventory), is in insufficiently supplied (such as for low inventory), etc. In the event the system and method determines that the state is no longer persistent (i.e. the conformity of persistence of a state is negative), then the system and method may then detect a transition from a first state to a second state or detect the second state.

In an exemplary embodiment, the system may use the states, predictions, aggregated data, areas of interest, analyzed data, object detection, among other analytic tools to keep track a metric corresponding to the process. The metrics may be any attribute of interest, such as, for example, in use time, down time, transitions, quantity per duration, cycles per duration, duration between transitions in state, number of transitions in state over time, types of transitions, types of states, and any combination thereof. The metric may correspond to a conformity of persistence of a given state.

In an exemplary embodiment, the system and methods may use the states, predictions, aggregated data, areas of interest, analyzed data, object detection, and other analysis to dynamically adjust the fidelity of the data being analysed. The fidelity of the data may be in time, such as fewer or greater number of image frames or sampled data points are retrieved and/or analyzed in a given time duration, or in data, such as in the resolution of the image or signal. For example, an area of an image not of interested may be reduced in data resolution, while areas of interest may be retained and/or increased in data resolution. For periods when a state is expected to remain static, the time fidelity of the data may be reduced, in that fewer data points/images are observed or analyzed over a given period of time. In other words, the sample rate may be reduced.

Embodiments of the system and method may therefore adaptively vary a fidelity of the received data based on meta information, user inputs, processed outputs from one or more signal sources, or combinations thereof. For example, when a sensor indicates an increase in temperature that may indicate a concern, the fidelity (either in resolution or sampling rate) may be increased. Other inputs may include user inputs, such that a user may indicate heightened areas of interest or concern, actions within a process, locations within a process, that may increase or decrease the fidelity of the data analyzed.

In an exemplary embodiment, the one or more data sources includes at least one data stream of sequential images and the analyzing the received data comprises defining an area of interest in an image of the sequential images. A fidelity of data of the image may be changed based on the area of interest. The fidelity of a signal resolution may be reduced in an area of lesser interest than the area of interest. A single processing frame may be generated from two or more images from the one or more data sources, and the fidelity of data of the single processing frame may be reduced by increasing a time separation between the two or more images (i.e. decreasing the sampling rate). Varying the fidelity may include removing portions of data corresponding to areas of an image not under observation and/or enhancing other portions of the image that are of interest at a particular time of analysis. The areas not under observation and areas of interest may change over time based on an updated meta information, updated user inputs, updated processed outputs from one or more signal sources, or combinations thereof.

In an exemplary embodiment, the system and method may permit different visualization of the analyzed data. For example, the system may include a display system for providing visual feedback to the user. The user display may permit the process to be represented in steps, resources, or other categorical relationship. The user display may permit the each segment of the represented process to include an indication of a delay attributed to that segment. The visualization may also include information about the segment, such as the resources used, a metric corresponding to the segment, and combinations thereof.

In an exemplary embodiment, the visualization may permit a user to display a user interface on a display. The user interface may include one or more video segments that may be played from the one or more cameras based on the analyzed data. Exemplary video segments may be aggregated according to an identified event. For example, a user may want to observe when a resource is not being utilized, or when an inefficiency event is detected. In an exemplary embodiment, the user interface may include different visuals areas, such as one for playing the video clips, and one for providing a listing of a plurality of different video segments corresponding to different time segments having a same identifying event. The listing of a plurality of different video segments may also correspond to different time segments with each time segment being identified as any of a plurality of events.

In an exemplary embodiment, visualizing the data may include displaying a user interface on a display and the user interface includes displaying a graph of a metric generated from analyzing the received data. The system and method may also include receiving from a user an input corresponding to a location of the graph of the metric and displaying a video segment from the one or more cameras based on the received input. The visualization may further includes displaying a series of video segments from the one or more cameras corresponding to time interfaces on the graph for instances in which the metric is above or below a threshold. The series of video segments may also be selected based on any combination of desired attributes, such as an identity of the event, meta information, user inputs, processed outputs from one or more signal sources, the states, predictions, aggregated data, areas of interest, analyzed data, object detection, a value or relative value of a metric, or combinations thereof.

In an exemplary embodiment, the system and method may be configured to play two or more video segments from two or more cameras, or two or more video segments from the same camera simultaneously. The simultaneous playing of video clips may permit a complete representation of an event. The selection of the multiple video segments may be based on the analyzed data and/or in an identity of an event or combinations thereof. For example, if the analyzed data indicates a resource is not identified in a camera image, another camera image that has analyzed data indicating the resource is in the other camera image may be simultaneously displayed to a user to indicate that a resource is out of an expected location and to display where the resource actually is and how the resource is actually being utilized. As another example, an event may be determined such as a transition state, e.g. reloading of a machine, which may implicate multiple camera views to fully review and observe the actions corresponding to the event. Therefore, the user interface may include more than one video segment from one, two, or more cameras based on an identity of the event, meta information, user inputs, processed outputs from one or more signal sources, the states, predictions, aggregated data, areas of interest, analyzed data, object detection, metrics, or combinations thereof.

In an exemplary embodiment, the system and method may be configured to analyze the received data and improve and/or quantify the performance of the process. The system and method may be configured to detect one or more events and/or inefficiencies. The system and method may be configured to attribute a process delay to a segment of the process. The system and method may be configured to analyze the detected one or more events and/or inefficiencies and/or the process delay of each segment of the process to determine an overall efficiency of the process. The system and method may be configured to simulate effects of reallocation of resources and/or reorganization of process segments in order to provide an improvement in the process. An improvement may be based on any desired attribute, such as reducing resources, improving process time, increasing or decreasing machine up or down time, or to get the resources, and process segments into a desired attribute configuration.

Exemplary embodiments provided herein may include a search feature. The search feature may be configured to receive an input from a user. The input from the user may be through a user interface, such as a display, touch screen, keyboard, button, mouse, and combinations thereof. The user may, for example, type in a desired term or terms to search, the user may, for example, select from a drop down menu of a list of available options, or the user may provide other or a combination of inputs to the system. The system may be configured to take the input from the user and search on information within the system. The search feature may be used, for example, to identify episodes having a common root cause. The search feature may be used, for example, for identifying specific types of episodes. The search feature may be used, for example, for identifying episodes involving a specific or the same resource. The search feature may be used to identify episodes within a given time frame or of a given duration or less than or greater than a given duration. The search feature may be used to find matches based on a criteria, unmatches based on a criteria (such as events that do not match a given criteria), find criteria based one conditions, such as greater than, less than, before, after, equal to, etc. Exemplary embodiments, may therefore provide a database of information that may be searched and provide a set of results based on the search. Exemplary embodiments, may include tags associated with episodes, time durations, etc. as described herein. The system may then be configured to search on the tags and find the associated episodes, time durations, etc. that are associated with the tags. The system may also or alternatively track other information associated with an episode, time duration, etc. such as, for example, the resources involved, such that similar searching may be conducted on different parameters. Exemplary embodiments may, therefore, be provided to permit a user the ability to search/filter across episodes for specific events based on tags, duration of episodes, time of occurrence, performance thresholds, etc., and any combination thereof.

In an exemplary method, the system may be distributed including one or more cameras to observe a segment of the process. The method may further including using the observation and analyzed data from the one or more cameras to distribute additional sensors. If the analysis identifies locations of inefficiency within the process, the distribution of sensors may be about the locations of inefficiencies. The analysis of received data may include identifying an inefficiency, wherein an inefficiency is determined by an underutilized resource because of a branch in the process with one side of the branch creating a lag compared to another side of the branch. The analysis of received data may include identifying a root cause of the inefficiency. In an exemplary embodiment, a plurality of branches may generate data such that the analysis of the received data corresponding to a plurality of branches may be analyzed to identify a series of inefficiencies along the process at more than one branch. The system and method may be configured to generate an optimized process order in which at least one of the series of inefficiencies is reduced to improve an overall process efficiency. The system and method may include receiving an input from a user and analyzing the received data to define and identify an inefficiency based on the input. The input may correspond to a desired process improvement, such as to change the use of resource(s), change the processing time, etc. The method may further include analyzing branch points from an end of the process toward the beginning of the process to sequentially optimize the process.

In an exemplary embodiment, the system and method may include simulating effects based on changes made to the process. For example, the system may automatically generate variations of the process and/or may receive an input to generate variations of the process. Variations may include any attribute, such as relocation of resources, reorganization of process segment, adding or removing process segments, reallocation of resources, adding or removing resources, etc. Exemplary embodiments may therefore include simulating a process flow with a change in a process step and the analyzing received data further includes determining a process flow metric with the change, and the visualizing the received data further includes providing an estimate of a process flow with the change. The system and method may include receiving an input from a user through a user interface, and changing the process flow based on the user interface and predicting a resulting production performance based on the input.

In an exemplary embodiment, the system may be used to provide information to one or more users and/or process resources through an indicator. The indicator may be visual and/or audial. For example, an indicator may be used to identify when a resource is over or under-utilized and thus provide an indication when resources should be reallocated. If one resource is underutilized, such as a worker waiting on a part to arise, the system may be provided to indicate that the resource may move to another segment of the process that is could use assistance. Visual indicators may be used, such as colored lights to indicate when a resource should leave one area and go to another area, other indicators such as symbols, text, displays, audial instructions, sounds, buzzers, etc. may also be used. The system and/or method may therefore be configured to analyze the received data and determine when a resource within the process is under or over utilized, and the method/system provides a real time adaptive indicator for indicating when a resource is under-utilized to reallocate the resource.

As described herein, the system and methods may be used to identify a root cause of a condition within the process. The system and methods may receive an indication of a root cause from a user, and/or analyze the received data to determine a root cause. In an exemplary embodiment, the system is configured to receive and/or assign tags to data corresponding to a root cause. In an exemplary embodiment, the system may include a user interface for receiving an input from a user, and the system may display a video section from the one or more data sources; and receive a tag input from the user through the user interface, wherein the tag corresponds to a root cause of an inefficiency. The system may automatically determine a root cause of another inefficiency based on the tag corresponding to the root cause of the inefficiency. The system and method may determine a root cause of an inefficiency detected from the analyzed received data. The root cause may be identified by a tag associated with a video section of the one or more data sources. The event may also be identified by tagging associated video clips from the one or more data sources corresponding to the event. For example, if the system may detect that a worker is not in a desired station when a machine is normally or available to be in use, a user may observe a video clip associated with the non-use of the machine and indicate a tag of employee missing. The system may also be programmed to recognize the missing resource and provide the appropriate tag. The system may also learn from prior tags and determine that a missing resource receive a specific tag and then suggest a tag for video segments having similar states, conditions, and/or attributes.

Exemplary embodiments of the present system and methods may have multiple uses. As primarily described herein, the system and method may be used to observe a process efficiency and/or improve a process efficiency based on a desired objective (such as reducing resources, improving process time, improving machine working time, reducing waste, etc.). However, exemplary embodiments described herein may be used for many other objectives. The system and methods may be used to observe and critique resources (such as for personnel evaluations). The system and methods may be used for training. The systems and methods may be used for process monitoring, recording, quality assurance, quantification, etc. In an exemplary embodiment, the system and methods described herein may be used for monitoring inventory to determine a time to restock. The system may receive data about a supply of a resource and may analyze the received data to predict a time to exhaust the inventory. The system and methods may include additional features, such as an interface for automatically submitting an order or providing a notice to reorder the inventory. Exemplary embodiments described herein may also be used for quality assurance and/or monitoring a condition of a service or output from a process. The system and method may therefore analyze the received data to detect a level of quality of product produced by the process. Similarly, the system and method may analyze the received data to determine a level of quality of a service provided by the process. The analysis of the received data may also determine a level of compliance to a safety or specific process protocol. The system may, for example, monitor the received data for specific conditions, such as employees wearing safety gear in one or more areas. The system may, for example, monitor other conditions and states for compliance and providing indications, notices, reports, etc. corresponding to the analyzed data. Other conditions may also be used to define a specific process protocol. For example, a camera for observing temperature may be used to observe a temperature of personnel and/or equipment. The system may then observe a temperature relative to the object detected and a temperature threshold. For example, for observing personnel, the system may identify a temperature profile as belonging to a person and then measure the temperature against a threshold. The threshold may be used to determine if the personnel is working under good conditions, such as without fever, or to observe or avoid heat stroke. Other conditions may also be observed, such as safety spacing, space capacities, presence or absence of safety equipment, operation within safety limits, etc.

In an exemplary embodiment, a method of determining inefficiencies in a process, is provided, including providing one or more devices for generating time based data strings, including one or more cameras, processing the received data, analyzing the received data, and visualizing the processed and analyzed data. The method may further include positioning the one or more devices at an end process branch toward an end of the process path; determining an inefficiency in the process based on an observation of resources used at the end process branch; repositioning the one or more devices at an upstream process branch further upstream in the process path; determining an inefficiency in the process based on an observation of resources used at the upstream process branch; positioning one or more other devices at an upstream process branch further upstream in the process path; determining an inefficiency in the process based on an observation of resources used at the upstream process branch; and combinations thereof. The system and method may also prioritize an inefficiency in the process based on the end process branch over the upstream process branch.

Exemplary embodiments of the system may include automated intelligent bots for performing one or more functions described herein. For example, the automated intelligent bots may be configured to identify an episode, to determine the root cause of episodes, to tag episodes, make other analysis or associations described herein, provide and/or control the indicators, make recommendations, run simulations, etc.

Exemplary embodiments of the systems and methods described herein may include many applications and provide many benefits within that application. Exemplary embodiments provided herein include an intelligent integrated management system. The management system may include tiered operational performance dashboard, and a system of cameras, detectors, sensors, and combinations thereof to provide 24 hour, 7 day a week process oversight with abnormal condition notification. The system may provide management by exception instead of management by events, and provide a normalized and standardized operation across facility and across a company.

For example, for manufacturing, the system may provide, detect, determine, analyze, and/or improve: asset overall equipment effectiveness; root cause identification and prioritization; workflow optimization (automated line balancing); time to completion prediction and simulations; among others.

For quality assurance, the system and methods may permit yield monitoring and estimation, rework/scrap monitoring, automated defect identification.

For supply chain applications, the system and methods may be used for inventory monitoring and replenishment notifications, forecasting of inventory stock utilization and warehouse layout optimization.

For safety compliance, the system and methods may provide personal protective equipment verification, proximity monitoring or compliance monitoring and violation notification.

Exemplary embodiments described herein may be used in employee programs. The employee programs may be used in evaluating an employee during review. The employee program may be used in providing rewards and/or bonuses, such as in identifying an employee of the month or other recognition system. Exemplary embodiments may be used to identify and quantify the production of an employee and/or resource. The system may be configured to display the results as compared against other employees and/or resources. For example, the top five or ten production personnel may be identified and ranked. The system may display the results so that employees may be recognized, rewarded, and/or used to motivate each other. The system may be configured to assess, track, and apply benchmarks to the quantitative performance metrics of an employee. For example, in an employee reaches certain benchmarks, the system may be configured to determine, and record when the benchmark is reached and/or surpassed. The system may be configured to provide a notice of such events, and/or may be configured to communicate with another system, such as payroll or accounting to indicate the employee is eligible for a bonus or monetary reward. Exemplary embodiments described herein may therefore provide, automated and/or manual rewards, recognitions, and appreciations program to users for active use and performance outputs.

Exemplary embodiments described herein may provide an interface to communicate with other systems and/or provide a marketplace for different entities. For example, once the system has determined or received an input to identify the source of an episode, such as latency within in line because a machine (or any resource) is not available, the system may provide the user to search for, post, purchase, or otherwise communicate the need for the machine.

Exemplary embodiments may bring together or interface with other platforms and/or users. The system may provide the collaboration between different users that may have access to the system. The system may therefore permit different users to collaborate on a given episode, event, or other condition or information in the system. For example, the system may provide a chat channel for users to discuss episodes. The system may provide different users to provide comments, feedback, suggestions, etc. on a given episode. Exemplary embodiments, may permit a user to send messages or notices to installers, operational consultants, manufacturers, vendors, etc. to obtain necessary equipment to remedy a given root cause of an episode. The system may therefore provide a market place for installers, operational consultants, manufacturing automation/hardware/equipment vendors, etc. The system may provide an interface to another program for searching for and/or purchasing the necessary goods/services to remedy the root cause of an episode and/or may integrate the marketplace directly into the platform.

Exemplary embodiments of the system described herein can be based in software and/or hardware. While some specific embodiments of the invention have been shown the invention is not to be limited to these embodiments. For example, most functions performed by electronic hardware components may be duplicated by software emulation. Thus, a software program written to accomplish those same functions may emulate the functionality of the hardware components in input-output circuitry. The invention is to be understood as not limited by the specific embodiments described herein, but only by scope of the appended claims.

Exemplary embodiments described herein provide many combinations of benefits and/or system features that can be used to observe, analyzing, and/or improve processes within a facility.

Exemplary embodiments described herein include processing information from one or more sources. As described herein the source may comprise sensors. Th sensor may be for example, cameras, programmable logic controller, scanner (such as for bar codes or QR codes), software inputs, user inputs, sensor trends, or a combination thereof. The system may use the inputs from the one or more inputs to determine a start and/or end time for an event. The system may then determine whether an event is an episode. For example, if a given event takes longer than an expected threshold of time, then the system may identify the event as an episode. The episode may be an inefficiency event or critical event as described herein.

Exemplary embodiments described herein may include various displays for the information obtained by embodiments described herein. In an exemplary embodiment, user interface(s) are provided to associate inefficiency events (or critical events) with sensor information, such as camera video feeds. Exemplary embodiments may permit a user to control the video feed, such as making the video display faster, slower, jump between identified events. Other user interfaces ma provide heat maps of actions or locations of components parts and/or resources during the process.

In an exemplary embodiment, systems and methods described herein may be used to provide multiple timelines of events. The multiple timelines may be of different periods of time for the same process, different processes, different locations of the same process, different views or sensor feeds for the same process, the same process from different locations, facilitates, lines, shifts, etc. Therefore, exemplary embodiments may permit one or more timelines to compare processes.

In an exemplary embodiment, the system may be configured to synchronize the more than one timeline. As described herein, the timelines may be zoomed in and/or out. The timelines may therefore be zoomed together to keep the timelines together. In an exemplary embodiment, the timelines may be scrolled or moved together so that selection of a time in one timeline similarly selects the time within the other timeline.

Exemplary embodiments described herein may be used to identify episodes. Episodes may be identified based on inefficiencies in the process. For example, an inefficiency may be determined by tracking a time period to perform an action within a process, the system may track start and end times of an action, track the downtime of a resource, track the back up of components at a resource, etc. The system may associate a time associated with an inefficiency event based on the determined times compared to optimal use, average use, use from other processes and/or lines, from prior use, etc.

The periods may be determined based on data received from one or more sensors and/or analyzed by the system. For example, the system may use one or more cameras to determine the user of a resource. The system may use sensors, such as scanners, user inputs such as buttons, or other indicators, to determine when a part arrives at a process step and/or leaves the process step (such as when a component arrives at a station or user and when the component is out of the station or completed by the user). The system may use sensors or inputs from a machine or other resource to determine whether the machine or other resource is in use. The system may determine when a machine (or resource) is not in use, or when a component part is not at a station to determine that an inefficiency event is occurring and associated a delay time incurred based on the non-utilization of the resource. The inefficiency events may also be determined based on the idleness of a component part through the process steps. For example, the system and methods described herein may be used to identify when a component or components get backed up at a resource or station and/or are in transit from one station to another station. In this case, the delay time from when the component arrives at a station to when it is actually worked on at the station may be determined as the delay time. Therefore, when the component is idle may be seen as an inefficiency event. Similarly, the component may be considered idle when it is in transit from one station to the next because it is not being formed into the final part or product. Therefore, inefficiencies may occur from the utilization of the resources within the process (such as machines and/or personnel), and/or from the components or the product itself not progressing toward completion. The system may use any combination of sensors or system inputs to analyze the inefficiency event. For example, as described herein, the system may include bar code sensors for tracking the movement of components through the process, the system may use sensors to determine whether resources are in use, the system may use cameras to identify events, use, and/or positions of resources and/or components within a process.

Exemplary embodiments described herein may provide information about events or episodes. The system may determine an associated time that the given episode has on the entire process time. The system may therefore be configured to range episodes to allow a user to sort through episodes based on the length of time of the episode and/or on the impact the episodes has on the overall process.

Exemplary embodiments described herein may be used to identify an event. An events, time, duration, and type may be determined through one or more inputs to the system and/or as analyzed by the system. Exemplary embodiments may permit visualization of the event from one or more sources. The sources providing visualization may be from the sources used to identify the event and/or may be separate therefrom. For example, an event may be identified by scanning a component into and out of a station (such as with a bar code scanner), while the associate visualization is from a camera recording video of the station.

Exemplary embodiments of the systems and methods described herein permit processing of large amounts of data in fast processing times. The data streams may change fidelity of the data stream such as by changing sampling rates and/or resolution of images or data from the stream to process larger amounts of information. The fidelity of a data stream may be based on areas of interest so that background portions of an image are discarded, used in second iterations of analysis if the area of interest does not provide the analytical solution, and/or background portion of an image are processed at lower fidelity.

Exemplary embodiments may comprise segmenting a process into segments. A segment of a process may be based on portions of the process that occurs between branch points. A segment of a process may be based on events and/or use of resources, such as action performed on a component part at a machine, etc.

In an exemplary embodiment, the system may analyze segments to identify delays within a segment. The system and/or users, such as through the experimentation, may improve the delays within a segment.

The system may identify inefficiencies through the imbalance between segments. The system and/or users, such as through the experimentation, may rebalance the segments. Exemplary rebalancing may include moving resources from and/or to different segments.

Exemplary embodiments may be used to generate process definitions based on contracts provided in the system. For example, the system may observe the process under different situations, such as the availability of different resources. The system may then be used to optimize the process for the given constraints. The system may therefore define the process for those constraints. For a specific example, a process may run optimally using 25 people. However, on a given workday, the process line may only have 23 people. The system may therefore have observed the process using 23 people and can be used to optimize the process given the constraint of 23 people. The system may therefore be used to provide process steps, resource allocations, etc. based on constraints to the process at a given time. The system may be able to change the process definition over time to maintain an optimization of the process. For example, when the process starts, resource (personnel) may be used at the upstream end of the process, but once underway, resources (personnel) may be redistributed to downstream segments of the process. The system may be used to identify when transition and resource reallocation should occur and/or provide indications of when the reallocation should happen. The process may provide definition process definitions based on resources, skill sets (work history, use of different machines, prior efficiencies), etc. A sequence of process definitions may be used in order to optimize the process over time.

Exemplary embodiments of the systems and methods described herein may be used to track operator skill sets through live metrics, work history (hours worked) at a workstation (and/or for various product mixes), training sessions, efficiency metrics, comparison of operation to programmed operation steps, and/or combinations thereof. These tracked skill sets may be used to suggest operator distribution within a process such as when a shift changes to optimize a process line. These tracked skill sets may be used to suggest additional training for an operator to further improve their efficiencies or operations of the process line. These tracked skill sets may be used to suggest additional training for change over training, when one operation may be similar to another operation that an operator may already have shown proficiency for. The system may therefore track the relation of skill sets for different operations in order to suggest training for an operator to expand the skill sets of available operators for different operations.

As described herein, once the available resources are known to the system, the system may be configured to suggest an optimal sequence of process steps and associated resources (i.e. play books) that may be strung together based on the time varying nature of operator availability, machine available, product mix, operator skill sets etc. across shifts and within shifts. A play book may comprise a process plan for what resources to distribute, and/or how the resources are distributed (for example, where available carts are used and/or which personnel is used at which workstation). Exemplary embodiments of the play book may also include process steps at a particular workstation. The play books may be for a given workstation and/or for an entire process line that may be used in combination in order to optimize the process line for a given condition set, such as including a given resource availability and/or resource character set. In an exemplary embodiment, operator work assignments for a particular sequence and play book may be assigned based on tracked operator skill sets as described herein to optimize throughput of the process line as well as functional redundancy.

Exemplary embodiments of the system may take a series of inputs to define a process definition for use during a shift or period of time. For example, the system may receive as an input the personnel for a given shift, the equipment for a given shift, etc. The system may then define the distribution of resources, and where individual personnel should be operating. The system may take in the history of personnel experiment, use of machines, prior metrics associated with their work at different stations, etc. The system may therefore be used to optimize a process before the process starts and not simply observe processes already occurring.

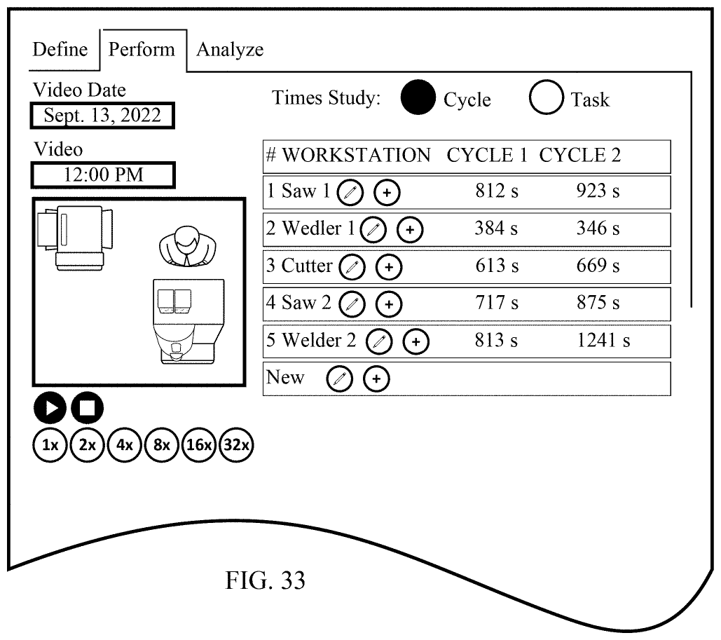

Exemplary embodiments described herein may be used to conduct time studies. FIG. 33 provides an exemplary user interface that may be used to create and compare times for a time study on tasks, and/or cycles within a process line. In an exemplary embodiment, the system may permit a user to identify one or more workstations, tasks, etc. in which the user wants to compare the amount of time taken associated with the event. As illustrated, the system permits a selection for cycle times of associated with workstations. The system may also or alternatively permit the display the associated time to conduct a given task or routine that may occur at or between workstations. The user may add one or more workstations to the system display. In an exemplary embodiment, the system may know the available workstations of a given process line or a portion thereof, and may permit a user to select which workstations, tasks, or other activity the user wants to compare. The system may thereafter permit the user to add cycles and/or may provide cycle times for the identified workstation, task, or activity for a given date and/or time. For example, the system may be configured to start at a particular time, and may then permit the user to add additional cycles through a user input indicating the addition of additional cycles for the given workstation/activity. The system may automatically provide the next cycle time based on the system analysis of the sensors associated with the given time. The system may also be configured to display one or more associated video feeds associated with the workstation and/or activity. The user may select a given cycle to play or see the given video associated with the cycle.

In an exemplary embodiment, the system may also permit the user to tag their own cycle start and stop times. As illustrated, the user may be able to play a video associated with a given workstation. The user interface may permit the user to indicate a start and/or stop time of one or more cycles by pushing, for example, start and/or stop buttons on the user interface. The user may also be permitted to select a video display speed so that the user may observe the video in a shorter duration in order to generate the cycle times. The system may receive the inputs and add additional cycles to the display of various cycle times. The system may thereafter permit a user to easily determine normal cycle durations, and/or anomaly cycle durations. The user may thereafter be permitted, through the user interface, to select one or more cycles for display. The user may thereafter observe the cycles of interest to conduct an efficient time analysis.

In an exemplary embodiment, the system may suggest cycle start and/or stop times. The cycle times may thereafter be adjusted by the user.

In an exemplary embodiment, the system may automatically adjust the video playback time according to anticipated cycle times. For example, a user may play a video, which may start at a single or double playback speed. Once the user has indicated a start of the cycle time, the system may be configured to play back the video at a higher playback speed. The system may be configured to estimate the cycle duration, and as the anticipated cycle end time is reach, such as at some predetermined time before the estimated cycle end time, the system may slow the playback speed. The system may slow the playback speed closer to an anticipated start and/or stop cycle time, and/or may increase the playback speed further away from the anticipated start and/or stop cycle time. The increases and/or decreases may occur at step wise intervals at predetermined intervals away from the estimated start and/or stop times of the cycle. The estimated start and/or stop times may be based on statistical assessment of prior cycle times for the given workstation. The estimated start and/or stop times may be based on the analysis of the system according to embodiments described herein, such as, for example, inputs at the workstation, recognition of events from the one or more sensors, the on or off time of a resources, such as a machine, other analysis of data as described herein, or combinations thereof.

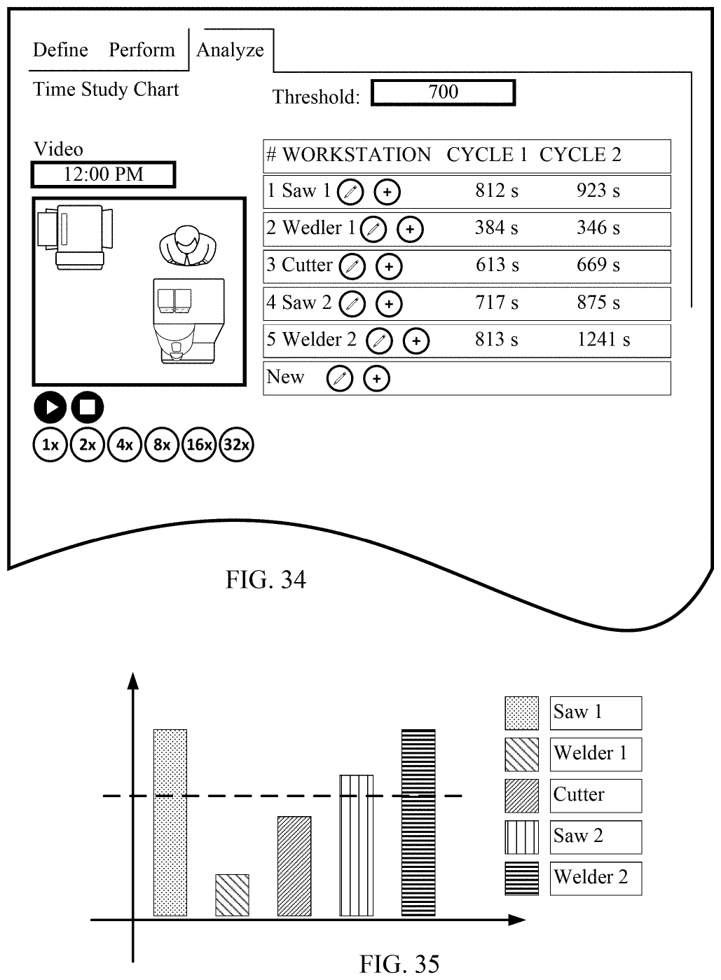

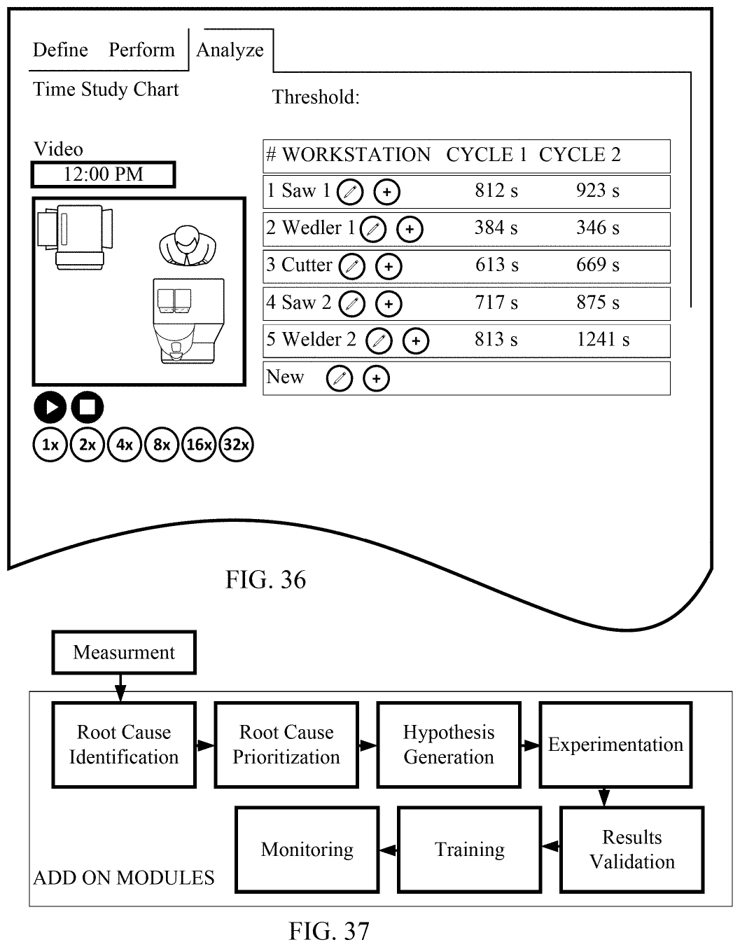

FIG. 35 illustrates an exemplary user interface that provides information of the exemplary time study from FIG. 34 in another way. As illustrated, once the cycles are identified, the cycles may be observed through a cycle graph that provides the various workstations and corresponding cycle times. The system may receive or provide a threshold time to indicate which machines exceed a threshold. The system may therefore provide a visualization of a process that permits easy indication or observation of a process or workstation that exceeds a threshold.

Exemplary embodiments include connecting data to video streams to provide a table of video enabled cycle times across one or more workstations and/or activities. The system may use the cycle times to generate a line balancing graphical chart. The chart may include a threshold time to compare the cycle times of one or more of the workstations and/or activities against the threshold time.

Exemplary embodiments described herein may permit manual time studies, such as through the user interfaces of FIGS. 34 and 35 described herein. The time studies may be conducted through retrospective video analysis. For example, a user may use the fast playback speed to observe video segments and indicate cycle times for analysis. The user may enter start and/or stop times for one or more cycles from observation of one or more videos. Exemplary embodiments may automatically adjust video playback speeds based on past data and/or system analyzed data so that video playback is slower near a likely user input events, such as the cycle start and/or stop time. Exemplary embodiments of the automated playback speeds may also be used in other situations of the system, such as during user tagging of events or recognition of inefficiency events.

Exemplary embodiments of the system architecture described herein may include machine communication directly from the machine to the system architecture. For example, communication devices may be added to machines so that the machine may directly provide information to the system, such as indicating start and stop times of the machine. Accordingly, derived information may be obtained from the machine metrics (such as using on and off times of a machine to determine a cycle time). Exemplary embodiments described herein may include wireless transmitter to communicate information from the machine and/or sensors to the system architecture. Exemplary embodiments of the system may also or alternatively use external sensors to determine or derive similar information for the machine. Exemplary embodiments described herein may use the machine information and/or sensor information combined with camera feed information. The system may thereafter use the cameras and/or sensor and/or machine information to identify root cause of inefficiencies. Exemplary embodiments include wireless input/output transmitter that can be wired to a machine to wirelessly communicate information from the machine to the system platform. Exemplary information of the input/output transmitter may communicate machine on/off information.

Exemplary embodiments described herein may include a website or software application that provides information to a user for improving process lines. In an exemplary embodiment, the system may provide a user with a library of courses. The courses may include information on how to use the system. The courses may include training information on how to perform actions at a workstation, including, for example how to work machines, how to conduct maintenance, etc.

Exemplary embodiments of the resources included herein may include training sessions. The training session may include images, videos, instructions, etc. to explain an action, including how to use a machine, perform an action at a workstation, open and/or close a workstation, and/or perform maintenance at a workstation or on a machine. The system may permit the user to answer questions after the training so that the user comprehension is tested. The system may keep track of the user responses, user score, time and/or duration of the training, etc. and associate the information in the skill matrix of the operator receiving the training.

FIG. 37 illustrates an exemplary system configuration that permits different modules to be included in different combinations with in systems. For example, the system may be configured to receive data and analyze the data. From the data measurements, the system may also include any modules described herein in any combination, such as, without limitation, modules for identify root causes, prioritizing root causes based on inefficiency time contributions, generate hypothesis of root causes and/or solutions thereto, permit experimentations to improve processes by addressing the root causes, validate results of changes made to a system to address root causes and improve inefficiency events, provide training, and continue monitoring of a system through real time notifications.

Although embodiments of this invention have been fully described with reference to the accompanying drawings, it is to be noted that various changes and modifications will become apparent to those skilled in the art. Such changes and modifications are to be understood as being included within the scope of embodiments of this invention as defined by the appended claims. Specifically, exemplary components are described herein. Any combination of these components may be used in any combination. For example, any component, feature, step or part may be integrated, separated, sub-divided, removed, duplicated, added, or used in any combination and remain within the scope of the present disclosure. Embodiments are exemplary only, and provide an illustrative combination of features, but are not limited thereto. When used in this specification and claims, the terms “comprises” and “comprising” and variations thereof mean that the specified features, steps or integers are included. The terms are not to be interpreted to exclude the presence of other features, steps or components. The features disclosed in the foregoing description, or the following claims, or the accompanying drawings, expressed in their specific forms or in terms of a means for performing the disclosed function, or a method or process for attaining the disclosed result, as appropriate, may, separately, or in any combination of such features, be utilized for realizing the invention in diverse forms thereof.

The invention claimed is:

1. A method of visualizing a process, comprising:
receiving data from one or more data sources, including one or more cameras;
analyzing the received data to identify one or more inefficiency events in the process; and
visualizing the analyzed data.

2. The method of claim 1, wherein the visualizing the analyzed data includes displaying a user interface on a display and the user interface includes a video segment from the one or more cameras based on the analyzed data identifying an identity of the inefficiency event.

3. The method of claim 2, wherein the user interface also includes a listing of a plurality of different video segments corresponding to different time segments having a same identity of the inefficiency event.

4. The method of claim 2, wherein the user interface also includes a listing of a plurality of different video segments corresponding to different time segments with each time segment being identified as any of a plurality of different identities of the inefficiency events.

5. The method of claim 2, wherein the user interface includes more than one video segment from two or more cameras based on the identity of the inefficiency event.

6. The method of claim 2, wherein the user interface includes a timeline of video segments.

7. The method of claim 6, wherein the user interface comprises a plurality of timelines, wherein each timeline is associated with different data from different one or more data sources.

8. The method of claim 6, wherein the user interface permits a user interface input to zoom in and out, wherein the timeline that is zoomed out provides an indicator of a total number of inefficiency events and corresponding time effect based on the total number of inefficiency events, and the timeline that is zoomed out provides a second indicator of the identity of the inefficiency event and an associated duration of the inefficiency event on the zoomed in timeline.

9. The method of claim 1, wherein the visualizing includes displaying a user interface on a display and the user interface includes displaying a graph of a metric generated from the analyzing the received data.

10. The method of claim 9, wherein the visualization includes receiving from a user an input corresponding to a location of the graph of the metric and displaying a video segment from the one or more cameras based on the received input.

11. The method of claim 9, wherein the visualization further includes displaying a series of video segments from the one or more cameras corresponding to time interfaces on the graph for instances in which the metric is above or below a threshold.

12. The method of claim 1, further comprising using analysis of the received data to distribute sensors, and the analysis of the received data identifies locations of inefficiency within the process, and the distribution of sensors is about the locations of inefficiencies.

13. The method of claim 1, wherein the analysis of received data comprises identifying an inefficiency, wherein an inefficiency is determined by an underutilized resource because of a branch in the process with one side of the branch creating a lag compared to another side of the branch.

14. The method of claim 13, wherein the analysis of received data comprises identifying a root cause of the inefficiency.

15. The method of claim 13, wherein the analysis comprises analyzing received data corresponding to a plurality of branches to identify a series of inefficiencies along the process at more than one branch.

16. The method of claim 15, further comprising providing an optimized process order in which at least one of the series of inefficiencies is reduced to improve an overall process efficiency.

17. The method of claim 16, further comprising receiving an input from a user and analyzing the received data to define and identify an inefficiency based on the input.

18. The method of claim 17, wherein the received input indicates a desired result including a reduction of resources, an improvement in process time, an improvement in resource usage, and combinations thereof.

19. The method of claim 1, further comprising analyzing branch points from an end of the process toward the beginning of the process to sequentially optimize the process.
